(19) United States
(12) Patent Application Publication
(10) Pub. No.: US 2025/0276818 A1
(43) Pub. Date: Sep. 4, 2025

(54) ROBOTIC PACKAGE HANDLING SYSTEMS AND METHODS

(71) Applicant: AMBI Robotics, Inc., Berkeley, CA (US)

(72) Inventors: Mathew Matl, Fremont, CA (US); David Gealy, Berkeley, CA (US); Stephen McKinley, Berkeley, CA (US); Jeffrey B. Mahler, Berkeley, CA (US)

(73) Assignee: AMBI Robotics, Inc., Berkeley, CA (US)

(21) Appl. No.: 18/916,609

(22) Filed: Oct. 15, 2024

Related U.S. Application Data
(63) Continuation of application No. 17/827,655, filed on May 27, 2022, now abandoned.
(60) Provisional application No. 63/193,775, filed on May 27, 2021.

(51) Int. Cl. B65B 35/38; B25J 9/16; B25J 15/06

(52) U.S. Cl. CPC B65B 35/38; B25J 9/1697; B25J 15/0616; G05B 2219/40053; G05B 2219/40607; G05B 2219/45063

(57) ABSTRACT

One embodiment is directed to robotic package handling system, comprising: a. a robotic arm comprising a distal portion and a proximal base portion; b. an end effector coupled to the distal portion of the robotic arm; c. a place structure positioned in geometric proximity to the distal portion of the robotic arm; d. a pick structure in contact with one or more packages and positioned in geometric proximity to the distal portion of the robotic arm; e. a first imaging device positioned and oriented to capture image information pertaining to the pick structure and one or more packages; f. a first computing system operatively coupled to the robotic arm and the first imaging device, and configured to receive the image information from the first imaging device and command movements of the robotic arm based at least in part upon the image information; wherein the first computing system is configured to operate the robotic arm and end effector to conduct a grasp of a targeted package of the one or more packages from the pick structure, and release the targeted package to rest upon the place structure; and wherein the end effector comprises a first suction cup assembly coupled to a controllably activated vacuum load operatively coupled to the first computing system, the first suction cup assembly defining a first inner capture chamber configured such that conducting the grasp of the targeted package comprises pulling into and at least partially

### CROSS-REFERENCE TO RELATED APPLICATIONS

This Application is a continuation of U.S. application Ser. No. 17/827,655 titled “ROBOTIC PACKAGE HANDLING SYSTEMS AND METHODS” dated May 27, 2022, which claims the benefit of U.S. Provisional Application No. 63/193,775, filed on May 27, 2021, which is incorporated in its entirety by this reference.

### FIELD OF THE INVENTION

This invention relates generally to the field of robotics, and more specifically to a new and useful system and method for planning and adapting to object manipulation by a robotic system. More specifically the present invention relates to robotic systems and methods for managing and processing packages.

### BACKGROUND

Many industries are adopting forms of automation. Robotic systems, and robotic arms specifically, are increasingly being used to help with the automation of manual tasks. The cost and complexity involved in integrating robotic automation, however, are limiting this adoption.

Because of the diversity of possible uses, many robotic systems are either highly customized and uniquely designed for a specific implementation or are very general robotic systems. The highly specialized solutions can only be used in limited applications. The general systems will often require a large amount of integration work to program and setup for a specific implementation. This can be costly and time consuming.

Further complicating the matter, many potential uses of robotic systems have changing conditions. Traditionally, robots have been designed and configured for various uses in industrial and manufacturing settings. These robotic systems generally perform very repetitive and well-defined tasks. The increase in e-commerce, however, is resulting in more demand for forms of automation that must deal with a high degree of changing or unknown conditions. Many robotic systems are unable to handle a wide variety of objects and/or a constantly changing variety of objects, which can make such robotic systems poor solutions for the product handling tasks resulting from e-commerce. Thus, there is a need in the robotics field to create a new and useful system and method for planning and adapting to object manipulation by a robotic system. This invention provides such new and useful systems and methods.

### BRIEF DESCRIPTION OF THE DRAWINGS

FIG. 1 illustrates a diagram of a robotic package handing system configuration;

FIG. 2 illustrates an embodiment of a changeable end effectord configuration;

FIG. 3 illustrates an embodiment of a head selector engaged with an end effector head;

FIG. 4 illustrates an embodiment of a head selector engaged with an end effector head having lateral supports;

FIG. 5 illustrates an embodiment of an end effector head having multiple selectable end effectors;

FIG. 6 illustrates an embodiment of an end effector head having multiple selectable end effectors;

FIGS. 7A-7G illustrate various aspects of an embodiment of a robotic package handling configuration;

FIGS. 8A-8B illustrate various aspects of suction cup assembly end effectors;

FIGS. 9A-9B illustrate various aspects of suction cup assembly end effectors;

FIGS. 10A-10F illustrate various aspects of embodiments of place structure configurations;

FIGS. 11A-11C illustrate various aspects of embodiments of robotic package handling configurations featuring one or more intercoupled computing systems;

FIG. 12 illustrates an embodiment of a computing architecture which may be utilized in implementing aspects of the subject configurations;

FIGS. 13-19 illustrate various embodiments of methods;

FIGS. 20A and 20B illustrate images of synthetic data.

### SUMMARY

One embodiment is directed to a system and method for planning and adapting to object manipulation by a robotic system functions to use dynamic planning for the control of a robotic system when interacting with objects. The system and method preferably employ robotic grasp planning in combination with dynamic tool selection. The system and method may additionally be dynamically configured to an environment, which can enable a workstation implementation of the system and method to be quickly integrated and setup in a new environment.

The system and method are preferably operated so as to optimize or otherwise enhance throughput of automated object-related task performance. This challenging problem can alternatively be framed as increasing or maximizing successful grasps and object manipulation tasks per unit tasks. For example, the system and method may improve the capabilities of a robotic system to pick objects from a first region (e.g., a bin), moving the object to a new location or orientation, and placing the object in a second region.

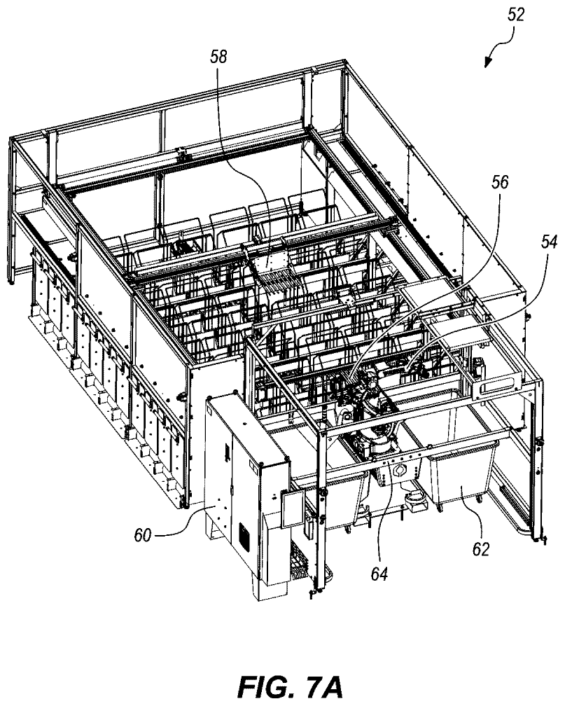

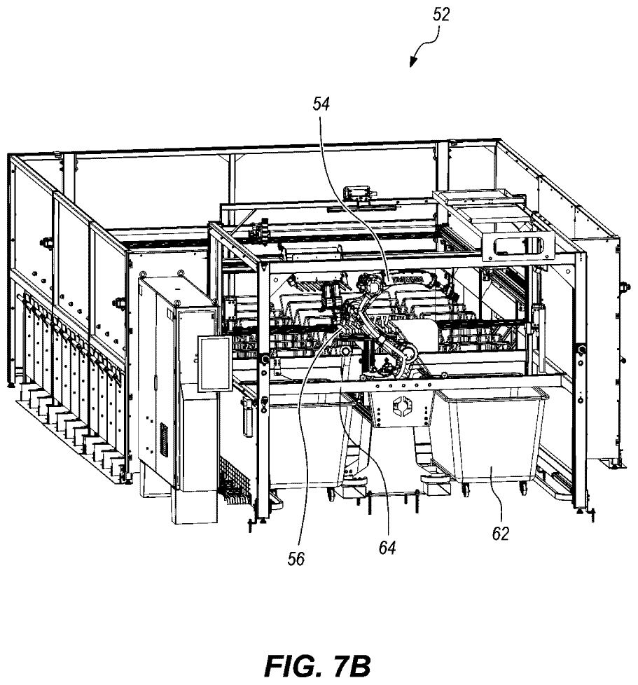

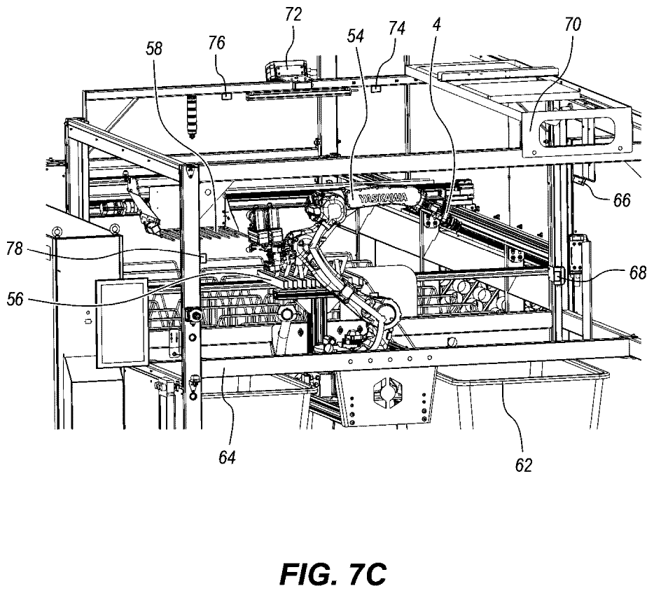

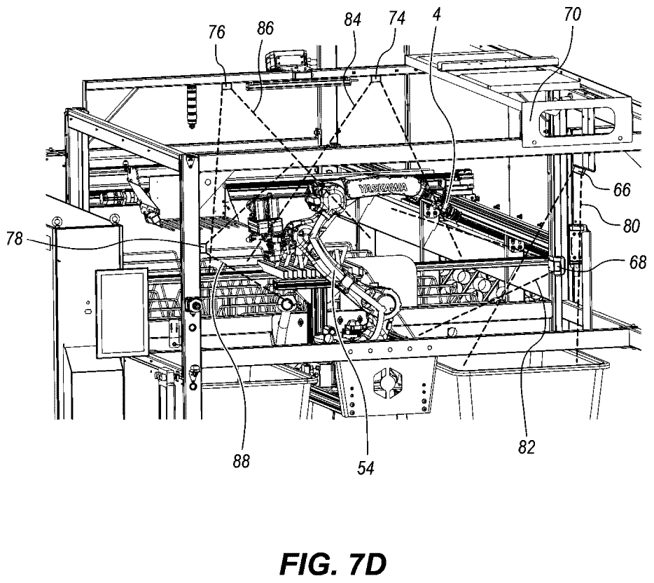

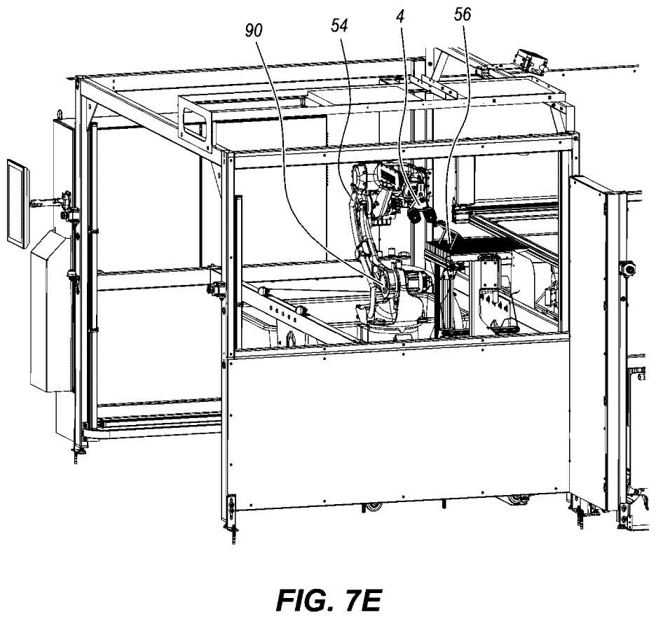

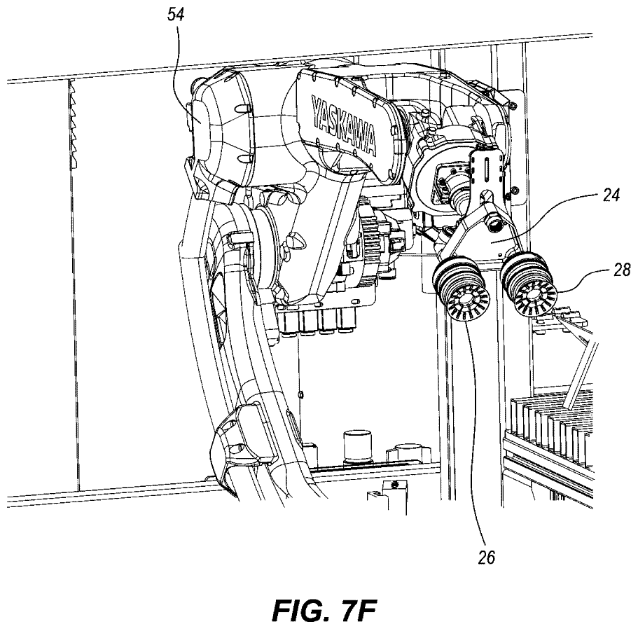

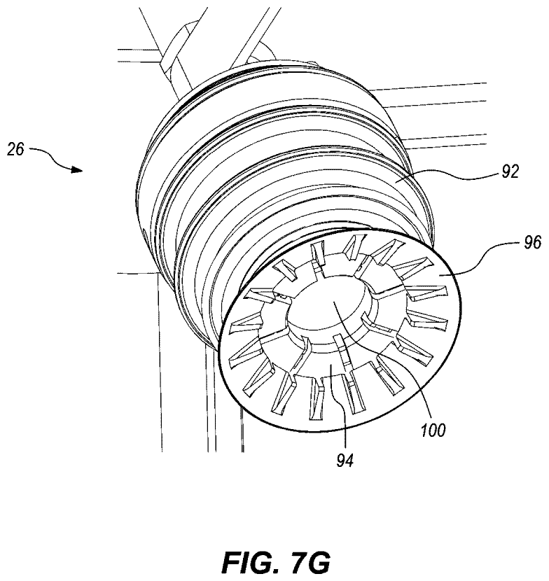

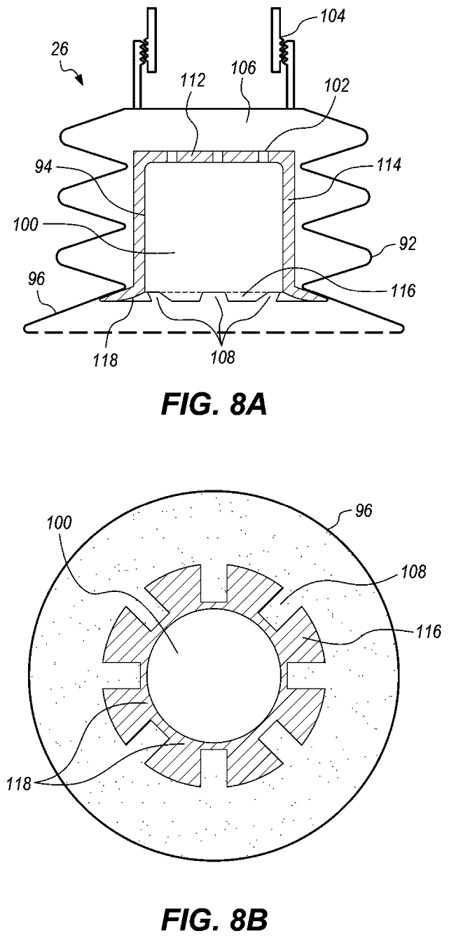

In one particular variation, the system and method employ the use of selectable and/or interchangeable end effectors to leverage dynamic tool selection for improved manipulation of objects. In such a multi-tool variation, the system and method may make use of a variety of different end effector heads that can vary in design and capabilities. The system and method may use a multi-tool with a set of selectively activated end effectors as shown in FIG. 7 and FIG. 8. In another variation, the system and method may use a changeable end effector head wherein the in-use end effector can be changed between a set of compatible end effectors.

By optimizing throughout, the system and method can enable unique robotic capabilities. The system and method can rapidly plan for a variety of end effector elements and dynamically make decisions on when to change end effector heads and/or how to use the selected tool. The system and method preferably account for the time cost of switching tools and the predicted success probabilities for different actions of the robotic system.

The unique robotic capabilities enabled by the system and method may be used to allow a wide variety of tools and more specialized tools to be used as end effectors. These capabilities can additionally, make robotic systems more adaptable and easier to configure for environments or scenarios where a wide variety of objects are encountered and/or when it is beneficial to use automatic selection of a tool. In the e-commerce application, there may be many situations where the robotic system is used for a collection of objects of differing types such as when sorting returned products or when consolidating products by workers or robots for order processing.

The system and method is preferably used for grasping objects and performing at least one object manipulation task. One preferred sequence of object manipulation tasks can include grasping an object (e.g., picking an object), moving the object to a new position, and placing the object, wherein the robotic system of the system and method operates as a pick-and-place system. The system and method may alternatively be applied to a variety of other object processing tasks such as object inspection, object sorting, performing manufacturing tasks, and/or other suitable tasks. While, the system and method are primarily described in the context of a pick-and-place application, the variations of the system and method described herein may similarly be applied to any suitable use-case and application.

The system and method can be particularly useful in scenarios where a diversity of objects needs to be processed and/or when little to no prior information is available for at least a subset of the objects needing processing.

The system and method may be used in a variety of use cases and scenarios. A robotic pick-and-place implementation of the system and method may be used in warehouses, product-handling facilities, and/or in other environments. For example, a warehouse used for fulfilling shipping orders may have to process and handle a wide variety of products. The robotic systems handing these products will generally have no 3D CAD or models available, little or no prior image data, and no explicit information on barcode position. The system and method can address such challenges so that a wide variety of products may be handled.

The system and method may provide a number of potential benefits. The system and method are not limited to always providing such benefits, and are presented only as exemplary representations for how the system and method may be put to use. The list of benefits is not intended to be exhaustive and other benefits may additionally or alternatively exist.

As one potential benefit, the system and method may be used in enhancing throughput of a robotic system. Grasp planning and dynamic tool selection can be used in automatically altering operation and leveraging capabilities of different end effectors for selection of specific objects. The system and method can preferably reduce or even minimize time spent changing tools while increasing or even maximizing object manipulation success rates (e.g., successfully grasping an object).

As another potential benefit, the system and method can more reliably interact with objects. The predictive modeling can be used in more successfully interacting with objects. The added flexibility to change tools can further be used to improve the chances of success when performing an object task like picking and placing an object.

As a related potential benefit, the system and method can more efficiently work with products in an automated manner. In general, a robotic system will perform some processing of the object as an intermediary step to some other action taken with the grasped object. For example, a product may be grasped, the barcode scanned, and then the product placed into an appropriate box or bin based on the barcode identifier. By more reliably selecting objects, the system and method may reduce the number of failed attempts. This may result in a faster time for handling objects thereby yielding an increase in efficiency for processing objects.

As another potential benefit, the system and method can be adaptable to a variety of environments. In some variations, the system and method can be easily and efficiently configured for use in a new environment using the configuration approach described herein. As another aspect, the multi-tool variations can enable a wide variety of objects to be handled. The system and method may not depend on collecting a large amount of data or information prior to being setup for a particular site. In this way, a pick-and-place robotic system using the system and method may be moved into a new warehouse and begin handling the products of that warehouse without a lengthy configuration process. Furthermore, the system and method can handle a wide variety of types of objects. The system and method is preferably well suited for situations where there is a diversity of variety and type of products needing handling. Although, instances of the system and method may similarly be useful where the diversity of objects is low.

As a related benefit, the system and method may additionally learn and improve performance over time as it learns and adapts to the encountered objects for a particular facility.

Another embodiment is directed to a robotic package handling system, comprising a robotic arm comprising a distal portion and a proximal base portion; an end effector coupled to the distal portion of the robotic arm; a place structure positioned in geometric proximity to the distal portion of the robotic arm; a pick structure in contact with one or more packages and positioned in geometric proximity to the distal portion of the robotic arm; a first imaging device positioned and oriented to capture image information pertaining to the pick structure and one or more packages; a first computing system operatively coupled to the robotic arm and the first imaging device, and configured to receive the image information from the first imaging device and command movements of the robotic arm based at least in part upon the image information; wherein the first computing system is configured to operate the robotic arm and end effector to conduct a grasp of a targeted package of the one or more packages from the pick structure, and release the targeted package to rest upon the place structure; and wherein the end effector comprises a first suction cup assembly coupled to a controllably activated vacuum load operatively coupled to the first computing system, the first suction cup assembly defining a first inner capture chamber configured such that conducting the grasp of the targeted package comprises pulling into and at least partially encapsulating a portion of the targeted package with the first inner capture chamber when the vacuum load is controllably activated adjacent the targeted package.

Another embodiment is directed to a robotic package handling system, comprising a robotic arm comprising a distal portion and a proximal base portion an end effector coupled to the distal portion of the robotic arm; a place structure positioned in geometric proximity to the distal portion of the robotic arm; a pick structure in contact with one or more packages and positioned in geometric proximity to the distal portion of the robotic arm; a first imaging device positioned and oriented to capture image information pertaining to the pick structure and one or more packages; a first computing system operatively coupled to the robotic arm and the first imaging device, and configured to receive the image information from the first imaging device and command movements of the robotic arm based at least in part upon the image information; wherein the first computing system is configured to operate the robotic arm and end effector to conduct a grasp of a targeted package of the one or more packages from the pick structure, and release the targeted package to rest upon the place structure; and wherein the end effector comprises a first suction cup assembly coupled to a controllably activated vacuum load operatively coupled to the first computing device, the first suction cup assembly defining a first inner chamber, a first outer sealing lip, and a first vacuum-permeable distal wall member which are collectively configured such that upon conducting the grasp of the targeted package with the vacuum load controllably activated, the outer sealing lip may become removably coupled to at least one surface of the targeted package, while the vacuum-permeable distal wall member prevents over-protrusion of said surface of the targeted package into the inner chamber of the suction cup assembly.

Another embodiment is directed to a robotic package handling system, comprising: a robotic arm comprising a distal portion and a proximal base portion; an end effector coupled to the distal portion of the robotic arm; a place structure positioned in geometric proximity to the distal portion of the robotic arm; a pick structure in contact with one or more packages and positioned in geometric proximity to the distal portion of the robotic arm;

a first imaging device positioned and oriented to capture image information pertaining to the pick structure and one or more packages; a first computing system operatively coupled to the robotic arm and the first imaging device, and configured to receive the image information from the first imaging device and command movements of the robotic arm based at least in part upon the image information; wherein the first computing system is configured to operate the robotic arm and end effector to conduct a grasp of a targeted package of the one or more packages from the pick structure, and release the targeted package to rest upon the place structure; and wherein the end effector comprises a first suction cup assembly coupled to a controllably activated vacuum load operatively coupled to the first computing system, the first suction cup assembly configured such that conducting the grasp comprises engaging the targeted package when the vacuum load is controllably activated adjacent the targeted package; and wherein before conducting the grasp, the computing device is configured to analyze a plurality of candidate grasps to select an execution grasp to be executed to remove the targeted package from the pick structure based at least in part upon runtime use of a neural network operated by the computing device, the neural network trained using views developed from synthetic data comprising rendered images of three-dimensional models of one or more synthetic packages as contained by a synthetic pick structure.

Another embodiment is directed to a robotic package handling system, comprising: a robotic arm comprising a distal portion and a proximal base portion; an end effector coupled to the distal portion of the robotic arm; a place structure positioned in geometric proximity to the distal portion of the robotic arm; a pick structure in contact with one or more packages and positioned in geometric proximity to the distal portion of the robotic arm; a first imaging device positioned and oriented to capture image information pertaining to the pick structure and one or more packages; a first computing system operatively coupled to the robotic arm and the first imaging device, and configured to receive the image information from the first imaging device and command movements of the robotic arm based at least in part upon the image information; wherein the first computing system is configured to operate the robotic arm and end effector to conduct a grasp of a targeted package of the one or more packages from the pick structure, and release the targeted package to rest upon the place structure; and wherein the end effector comprises a first suction cup assembly coupled to a controllably activated vacuum load operatively coupled to the first computing system, the first suction cup assembly configured such that conducting the grasp comprises engaging the targeted package when the vacuum load is controllably activated adjacent the targeted package; wherein the system further comprises a second imaging device operatively coupled to the first computing system and positioned and oriented to capture one or more images of the targeted package after the grasp has been conducted using the end effector to estimate the outer dimensional bounds of the targeted package by fitting a 3-D rectangular prism around the targeted package and estimating L-W-H of said rectangular prism, and to utilize the fitted 3-D rectangular prism to estimate a position and an orientation of the targeted package relative to the end effector; and wherein the first computing system is configured to operate the robotic arm and end effector to place the targeted package upon the place structure in a specific position and orientation relative to the place structure.

Another embodiment is directed to a system, comprising: a robotic pick-and-place machine comprising an actuation system and a changeable end effector system configured to facilitate selection and switching between a plurality of end effector heads; a sensing system; and a grasp planning processing pipeline used in control of the robotic pick-and-place machine.

Another embodiment is directed to a method for robotic package handing, comprising: a. providing a robotic arm comprising a distal portion and a proximal base portion, an end effector coupled to the distal portion of the robotic arm, a place structure positioned in geometric proximity to the distal portion of the robotic arm, a pick structure in contact with one or more packages and positioned in geometric proximity to the distal portion of the robotic arm, a first imaging device positioned and oriented to capture image information pertaining to the pick structure and one or more packages, and a first computing system operatively coupled to the robotic arm and the first imaging device, and configured to receive the image information from the first imaging device and command movements of the robotic arm based at least in part upon the image information; wherein the end effector comprises a first suction cup assembly coupled to a controllably activated vacuum load operatively coupled to the first computing system, the first suction cup assembly defining a first inner capture chamber; and b. utilizing the first computing system to operate the robotic arm and end effector to conduct a grasp of a targeted package of the one or more packages from the pick structure, and release the targeted package to rest upon the place structure; wherein conducting the grasp of the targeted package comprises pulling into and at least partially encapsulating a portion of the targeted package with the first inner capture chamber when the vacuum load is controllably activated adjacent the targeted package.

Another embodiment is directed to a method for robotic package handling, comprising: a. providing a robotic arm comprising a distal portion and a proximal base portion, an end effector coupled to the distal portion of the robotic arm, a place structure positioned in geometric proximity to the distal portion of the robotic arm, a pick structure in contact with one or more packages and positioned in geometric proximity to the distal portion of the robotic arm, a first imaging device positioned and oriented to capture image information pertaining to the pick structure and one or more packages, a first computing system operatively coupled to the robotic arm and the first imaging device, and configured to receive the image information from the first imaging device and command movements of the robotic arm based at least in part upon the image information; and b. utilizing the first computing system to operate the robotic arm and end effector to conduct a grasp of a targeted package of the one or more packages from the pick structure, and release the targeted package to rest upon the place structure; wherein the end effector comprises a first suction cup assembly coupled to a controllably activated vacuum load operatively coupled to the first computing device, the first suction cup assembly defining a first inner chamber, a first outer sealing lip, and a first vacuum-permeable distal wall member which are collectively configured such that upon conducting the grasp of the targeted package with the vacuum load controllably activated, the outer sealing lip may become removably coupled to at least one surface of the targeted package, while the vacuum-permeable distal wall member prevents over-protrusion of said surface of the targeted package into the inner chamber of the suction cup assembly.

Another embodiment is directed to a method for robotic package handling, comprising: a. providing a robotic arm comprising a distal portion and a proximal base portion, an end effector coupled to the distal portion of the robotic arm, a place structure positioned in geometric proximity to the distal portion of the robotic arm, a pick structure in contact with one or more packages and positioned in geometric proximity to the distal portion of the robotic arm, a first imaging device positioned and oriented to capture image information pertaining to the pick structure and one or more packages, a first computing system operatively coupled to the robotic arm and the first imaging device, and configured to receive the image information from the first imaging device and command movements of the robotic arm based at least in part upon the image information; and b. utilizing the first computing system to operate the robotic arm and end effector to conduct a grasp of a targeted package of the one or more packages from the pick structure, and release the targeted package to rest upon the place structure; wherein the end effector comprises a first suction cup assembly coupled to a controllably activated vacuum load operatively coupled to the first computing system, the first suction cup assembly configured such that conducting the grasp comprises engaging the targeted package when the vacuum load is controllably activated adjacent the targeted package; and wherein before conducting the grasp, the computing device is configured to analyze a plurality of candidate grasps to select an execution grasp to be executed to remove the targeted package from the pick structure based at least in part upon runtime use of a neural network operated by the computing device, the neural network trained using views developed from synthetic data comprising rendered images of three-dimensional models of one or more synthetic packages as contained by a synthetic pick structure.

Another embodiment is directed to a method for robotic package handling, comprising: a. providing a robotic arm comprising a distal portion and a proximal base portion, an end effector coupled to the distal portion of the robotic arm, a place structure positioned in geometric proximity to the distal portion of the robotic arm, a pick structure in contact with one or more packages and positioned in geometric proximity to the distal portion of the robotic arm, a first imaging device positioned and oriented to capture image information pertaining to the pick structure and one or more packages, a first computing system operatively coupled to the robotic arm and the first imaging device, and configured to receive the image information from the first imaging device and command movements of the robotic arm based at least in part upon the image information; and b. utilizing the first computing system to operate the robotic arm and end effector to conduct a grasp of a targeted package of the one or more packages from the pick structure, and release the targeted package to rest upon the place structure; wherein the end effector comprises a first suction cup assembly coupled to a controllably activated vacuum load operatively coupled to the first computing system, the first suction cup assembly configured such that conducting the grasp comprises engaging the targeted package when the vacuum load is controllably activated adjacent the targeted package; C. providing a second imaging device operatively coupled to the first computing system and positioned and oriented to capture one or more images of the targeted package after the grasp has been conducted using the end effector to estimate the outer dimensional bounds of the targeted package by fitting a 3-D rectangular prism around the targeted package and estimating L-W-H of said rectangular prism, and to utilize the fitted 3-D rectangular prism to estimate a position and an orientation of the targeted package relative to the end effector; and d. utilizing the first computing system to operate the robotic arm and end effector to place the targeted package upon the place structure in a specific position and orientation relative to the place structure.

Another embodiment is directed to a method, comprising: a. collecting image data of an object populated region; b. planning a grasp which is comprised of evaluating image data through a grasp quality model to generate a set of candidate grasp plans, processing candidate grasp plans and selecting a grasp plan; c. performing the selected grasp plan with a robotic system; and d. performing an object interaction task.

### DETAILED DESCRIPTION

The following U.S. Pat. Applications, serial numbered as follows, are incorporated by reference herein in their entirety: Ser. No. 17/220,679-publication 2021/0308874; Ser. No. 17/220,694-publication 2021/0308875; Ser. No. 17/404,748-publication 2022/0048707; and Ser. No. 17/468,220-publication 2022/0072587.

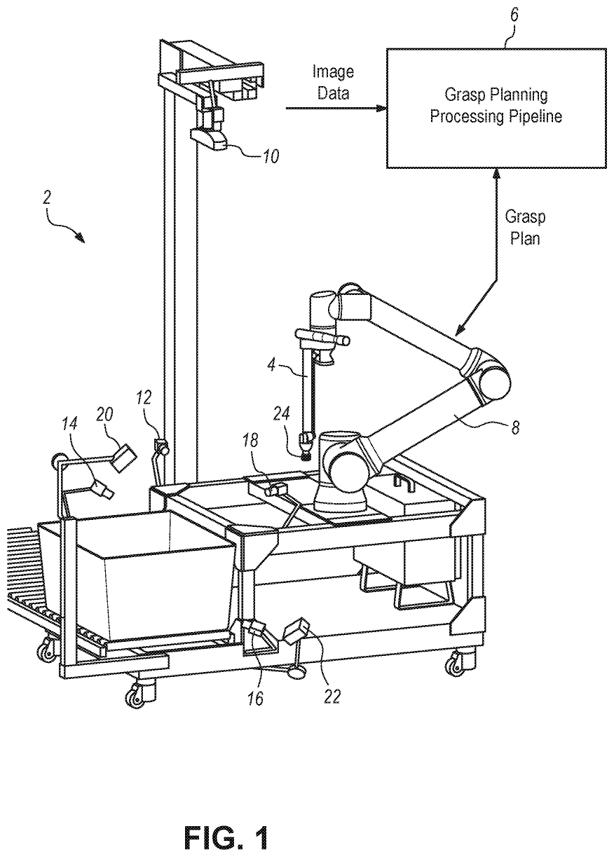

Referring to FIG. 1, a system for planning and adapting to object manipulation can include: a robotic pick-and-place machine (2) with an actuation system (8) and a changeable end effector system (4); a sensing system and a grasp planning processing pipeline (6) used in control of the robotic pick-and-place machine. The system and method may additionally include a workstation configuration module used in dynamically defining environmental configuration of the robotic system. The system is preferably used in situations where a set of objects in one region needs to be processed or manipulated in some way.

In many pick-and-place type applications, the system is used where a set of objects (e.g., products) are presented in some way within the environment. Objects may be stored and presented within bins, totes, bags, boxes, and/or other storage elements. Objects may also be presented through some item supply system such as a conveyor belt. The system may additionally need to manipulate objects to place objects in such storage elements such as by moving objects from a bin into a box specific to that object. Similarly, the system may be used to move objects into a bagger system or to another object manipulation system such as a conveyor belt.

The system may be implemented into an integrated workstation, wherein the workstation is a singular unit where the various elements are physically integrated. Some portions of the computing infrastructure and resources may however be remote and accessed over a communication network. In one example, the integrated workstation includes a robotic pick-and-place machine (2) with a physically coupled sensing system. In this way the integrated workstation can be moved and fixed into position and begin operating on objects in the environment. The system may alternatively be implemented as a collection of discrete components that operate cooperatively. For example, a sensing system in one implementation could be physically removed from the robotic pick-and-place machine. The workstation configuration module described below may be used in customized configuration and setup of such a workstation.

The robotic pick-and-place machine functions as the automated system used to interact with an object. The robotic pick-and-place machine (2) preferably includes an actuation system (8) and an end effector (4) used to temporarily physically couple (e.g., grasp or attach) to an object and perform some manipulation of that object. The actuation system is used to move the end effector and, when coupled to one or more objects, move and orient an object in space. Preferably, the robotic pick-and-place machine is used to pick up an object, manipulate the object (move and/or reorient and object), and then place an object when done. Herein, the robotic pick-and-place machine is more generally referred to as the robotic system. A variety of robotic systems may be used. In one preferred implementation, the robotic system is an articulated arm using a pressure-based suction-cup end effector. The robotic system may include a variety of features or designs.

The actuation system (8) functions to translate the end effector through space. The actuation system will preferably move the end effector to various locations for interaction with various objects. The actuation system may additionally or alternatively be used in moving the end effector and grasped object(s) along a particular path, orienting the end effector and/or grasped object(s), and/or providing any suitable manipulation of the end effector. In general, the actuation system is used for gross movement of the end effector.

The actuation system (8) may be one of a variety of types of machines used to promote movement of the end effector. In one preferred variation, the actuation system is a robotic articulated arm that includes multiple actuated degrees of freedom coupled through interconnected arm segments. One preferred variation of an actuated robotic arm is a 6-axis robotic arm that includes six degrees of freedom as shown in FIG. 1. The actuation system may alternatively be a robotic arm with fewer degrees of freedom such as a 4-axis or 5-axis robotic arm or ones with additional articulated degrees of freedom such as a 7-axis robotic arm.

In other variations, the actuation system may be any variety of robotic systems such as a Cartesian robot, a cylindrical robot, a spherical robot, a SCARA robot, a parallel robot such as a delta robot, and/or any other variation of a robotic system for controlled actuation.

The actuation system (8) preferably includes an end arm segment. The end arm segment is preferably a rigid structure extending from the last actuated degree of freedom of the actuation system. In an articulated robot arm, the last arm segment couples to the end effector (4). As described below, the end of the end arm segment can include a head selector that is part of a changeable end effector system.

In one variation, the end arm segment may additionally include or connect to at least one compliant joint.

The compliant joint functions as at least one additional degree of freedom that is preferably positioned near the end effector. The compliant joint is preferably positioned at the distal end of the end arm segment of the actuation system, wherein the compliant joint can function as a “wrist” joint. The compliant joint preferably provides a supplementary amount of dexterity near where the end effector interacts with an object, which can be useful during various situations when interacting with objects.

In a multi-tool changing variation of the system, the compliant joint preferably precedes the head selector component such that each attachable end effector head can be used with controllable compliance. Alternatively, one or more multiple end effectors may have a compliant joint.

In a multi-headed tool variation, a compliant joint may be integrated into a shared attachment point of the multi-headed end effector. In this way use of the connected end effectors can share a common degree of freedom at the compliant joint. Alternatively, one or more multiple end effectors of the multi-headed end effector may include a compliant joint. In this way, each individual end effector can have independent compliance.

The compliant joint is preferably a controllably compliant joint wherein the joint may be selectively made to move in an at least partially compliant manner. When moving in a compliant manner, the compliant joint can preferably actuate in response to external forces. Preferably, the compliant joint has a controllable rotational degree of freedom such that the compliant joint can rotate in response to external forces. The compliant joint can additionally preferably be selectively made to actuate in a controlled manner. In one preferred variation, the controllably compliant joint has one rotational degree of freedom that when engaged in a compliant mode rotates freely (at least within some angular range) and when engaged in a controlled mode can be actuated so as to rotate in a controlled manner. Compliant linear actuation may additionally or alternatively be designed into a compliant joint. The compliant joint may additionally or alternatively be controlled for a variable or partially compliant form of actuation, wherein the compliant joint can be actuated but is compliant to forces above a particular threshold.

The end effector (4) functions to facilitate direct interaction with an object. Preferably, the system is used for grasping an object, wherein grasping describes physically coupling with an object for physical manipulation. Controllable grasping preferably enables the end effector to selectively connect/couple with an object (“grasp” or “pick”) and to selectively disconnect/decouple from an object (“drop” or “place”). The end effector may controllably “grasp” an object through suction force, pinching the object, applying a magnetic field, and/or through any suit force. Herein, the system is primarily described for suction-based grasping of the object, but the variations described herein are not necessarily limited to suction-based end effectors.

In one preferred variation, the end effector (4) includes a suction end effector head (24, which may be more concisely referred to as a suction head) connected to a pressure system. A suction head preferably includes one or more suction cups (26, 28, 30, 32). The suction cups can come in variety of sizes, stiffnesses, shapes, and other configurations. Some examples of suction head configurations can include a single suction cup configuration, a four suction cup configuration, and/or other variations. The sizes, materials, geometry of the suction heads can also be changed to target different applications. The pressure system will generally include at least one vacuum pump connected to a suction head through one or more hoses.

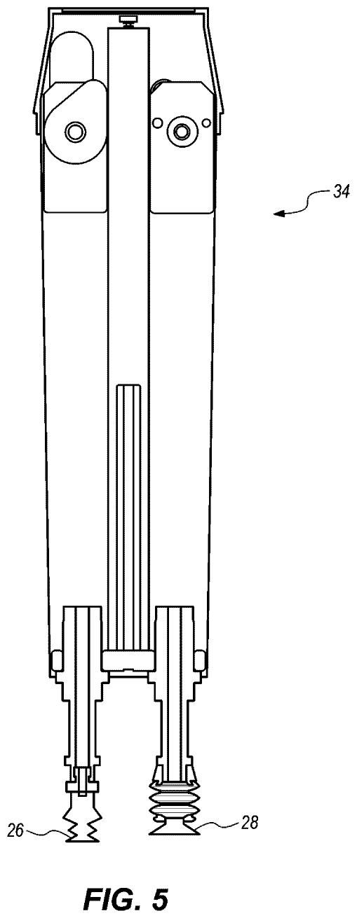

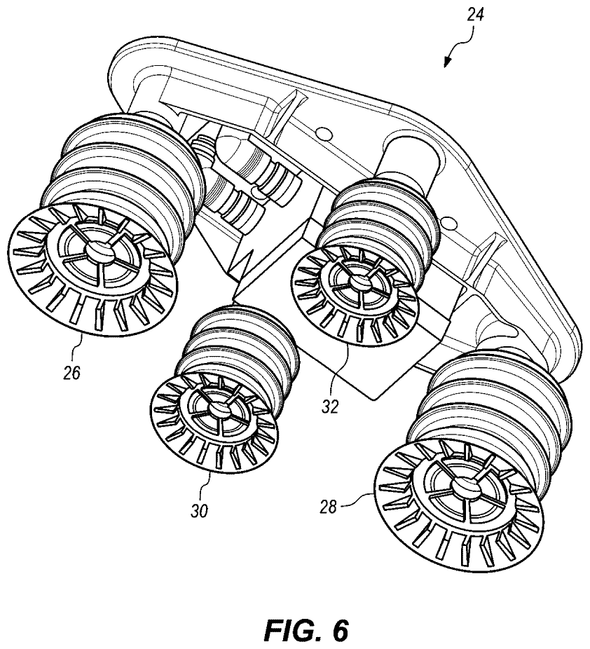

In one preferred variation, the end effector of the system includes a multi-headed end effector tool that includes multiple selectable end effector heads as shown in exemplary variations FIG. 5 (34) and FIG. 6 (24). Each end effector head can be connected to individually controlled pressure systems. The system can selectively activate one or multiple pressure systems to grasp using one or multiple end effectors of the multi-headed end effector tool. The end effector heads are preferably selected and used based on dynamic control input from the grasp planning model. The pressure system(s) may alternatively use controllable valves to redirect airflow. The different end effectors are preferably spaced apart. They may be angled in substantially the same direction, but the end effectors may alternatively be directed outwardly in non-parallel directions from the end arm segment.

As shown in the cross-sectional view of FIG. 5, one exemplary variation of a multi-headed end effector tool can be a two-headed gripper (34). This variation may be specialized to reach within corners of deep bins or containers and pick up small objects (e.g., small items like a pencil) as well as larger objects (such as boxes). In one variation, each of the gripping head end effectors may be able to slide linearly on a spring mechanism. The end effector heads may be coupled to hoses that connect to the pressure system(s). The hoses can coil helically around the center shaft (to allow for movement) to connect the suction heads to the vacuum generators.

As shown in FIG. 6, another exemplary variation of a multi-headed end effector tool (24) can be a multi four-headed gripper. As shown in this variation, various sensors such as a camera or barcode reader can be integrated into the multi-headed end effector tool, shown here in the palm. Suction cup end effector heads can be selected to have a collectively broad application (e.g., one for small boxes, one for large boxes, one for loose polybags, one for stiffer polybags). The combination of multiple grippers can pick objects of different sizes. In some variations, this multi-headed end effector tool may be connected to the robot by a spring plunger to allow for error in positioning.

In another preferred variation of the system includes a changeable end effector system, which functions to enable the end effector to be changed. A changeable end effector system preferably includes a head selector (36), which is integrated into the distal end of the actuation system (e.g., the end arm segment), a set of end effector heads, and a head holding device (38), or tool holder for socalled “tool switching”. The end effector heads are preferably selected and used based on dynamic control input from the grasp planning model. The head selector and an end effector head preferably attach together at an attachment site of the selector and the head. One or more end effector head can be stored in the head holding device (38) when not in and use. The head holding device can additionally orient the stored end effector heads during storage for easier selection. The head holding device may additionally partially restrict motion of an end effector head in at least one direction to facilitate attachment or detachment from the head selector.

The head selector system functions to selectively attach and detach to a plurality of end effector heads. The end effector heads function as the physical site for engaging with an object. The end effectors can be specifically configured for different situations. In some variations, a head selector system may be used in combination with a multi-headed end effector tool. For example, one or multiple end effector heads may be detachable and changed through the head selector system.

The changeable end effector system may use a variety of designs in enabling the end effectors to be changed. In one variation, the changeable end effector is a passive variation wherein end effector heads are attached and detached to the robotic system without use of a controlled mechanism. In a passive variation, the actuation and/or air pressure control capabilities of the robotic system may be used to engage and disengage different end effector heads. Static magnets (44, 46), physical fixtures (48) (threads, indexing/alignment structures, friction-fit or snap-fit fixtures) and/or other static mechanism may also be used to temporarily attach an end effector head and a head selector.

In another variation, the changeable end effector is an active system that uses some activated mechanism (e.g., mechanical, electromechanical, electromagnetic, etc.) to engage and disengage with a selected end effector head. Herein, a passive variation is primarily used in the description, but the variations of the system and method may similarly be used with an active or alternative variation.

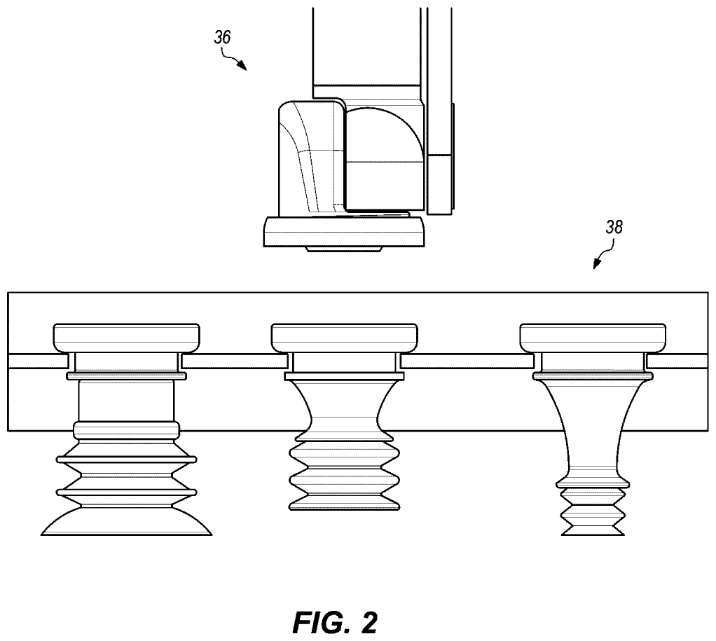

One preferred variation of the changeable end effector system is designed for use with a robotic system using a pressure system with suction head end effectors. The head selector can further function to channel the pressure to the end effector head. The head selector can include a defined internal through-hole so that the pressure system is coupled to the end effector head. The end effector heads will generally be suction heads. A set of suction end effector heads can have a variety of designs as shown in FIG. 2.

The head selector and/or the end effector heads may include a seal (40, 42) element circumscribing the defined through-hole. The seal can enable the pressure system to reinforce the attachment of the head selector and an end effector head. This force will be activated when the end effector is used to pick up an object and should help the end effector head stay attached when loaded with an outside object.

The seal (40, 42) is preferably integrated into the attachment face of the head selector, but a seal could additionally or alternatively be integrated into the end effector heads. The seal can be an O-ring, gasket, or other sealing element. Preferably, the seal is positioned along an outer edge of the attachment face. An outer edge is preferably a placement along the attachment face wherein there is more surface of the attachment face on an internal portion as compared to the outer portion. For example, in one implementation, a seal may be positioned so that over 75% of the surface area is in an internal portion. This can increase the surface area over-which the pressure system can exert a force.

Magnets (44, 46) may be used in the changeable end effector system to facilitate passive attachment. A magnet is preferably integrated into the head selector and/or the set of end effector heads. In a preferred variation, a magnet is integrated into both the head selector and the end effector heads. Alternatively, a magnet may be integrated into one of the head selectors or the end effector head with the other having a ferromagnetic metal piece in place of a magnet.

In one implementation, the magnet has a single magnet pole aligned in the direction of attachment (e.g., north face of a magnet directed outward on the head selector and south face of a second magnet directed outward on each end effector head). Use of opposite poles in the head selector and the end effector heads may increase attractive force.

The magnet can be centered or aligned around the center of an attachment site. The magnet in one implementation can circumscribe the center and a defined cavity though which air can flow for a pressure-based end effector. In another variation, multiple magnets may be positioned around the center of the attachment point, which could be used in promoting some alignment between the head selector and an end effector head. In one variation, the magnet could be asymmetric about the center off-center and/or use altering magnetic pole alignment to further promote a desired alignment between the head selector and an end effector head.

In one implementation, a magnet can supply initial seating and holding of the end effector head when not engaged with an object (e.g., not under pressure) and the seal and/or the pressure system can provide the main attractive force when holding an object.

The changeable end effector system can include various structural elements that function in a variety of ways including providing reinforcement during loading, facilitating better physical coupling when attached, aligning the end effector heads when attached (and/or when in the head holding device), or providing other features to the system.

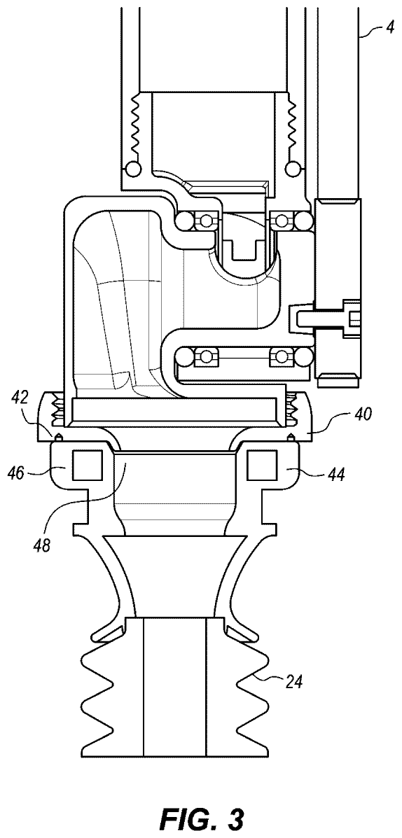

In one structural element variation, the head selector and the end effector heads can include complimentary registration structures as shown in FIG. 3. A registration structure can be a protruding or recessed feature of the attachment face of the head selector and/or the end effector. In one variation, the registration structure is a groove or tooth. A registration structure may be used to restrict how a head selector and an end effector head attach. The head selector and the set of end effector heads may include one set of registration structures or a plurality of registration structure pairs. The registration structure may additionally or alternatively prevent rotation of the end effector head. In a similar manner, the registration structure can enable torque to be transferred through the coupling of the head selector and the end effector head.

In another structural element variation, the changeable end effector system can include lateral support structures (50) integrated into one or both of the head selector and the end effector heads. The lateral support structure functions to provide structural support and restrict rotation (e.g., rotation about an axis perpendicular to a defined central axis of the end arm segment). A lateral support structure preferably provides support when the end effector is positioned horizontally while holding an object. The lateral support structure can prevent or mitigate the situations where a torque applied when grasping an object causes the end effector head to be pulled off.

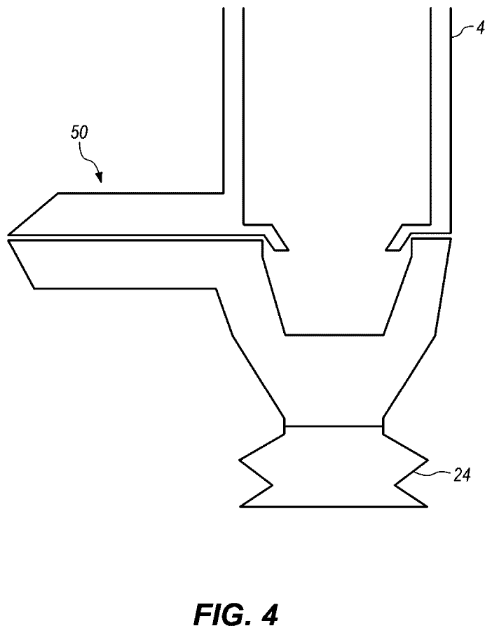

A lateral support structure (50) can be an extending structural piece that has a form that engages with the surface of the head selector and/or the end arm segment. A lateral support structure can be on one or both head selector and end effector head (4). Preferably, complimentary lateral support structures are part of the body of the head selector and the end effector arms. In one variation, the complimentary lateral support structures of the end-effector and the head selector engage in a complimentary manner when connected as shown in FIG. 4.

There can be a single lateral support structure. With a single lateral support structure, the robotic system may actively position the lateral support structure along the main axis benefiting from lateral support when moving an object. The robotic system in this variation can include position tracking and planning configuration to appropriately pick up an object and orient the end effector head so that the lateral support is appropriately positioned to provide the desired support. In some cases, this may be used for only select objects (e.g., large and/or heavy objects). In another variation, there may be a set of lateral support structures. The set of lateral support structures may be positioned around the perimeter so that a degree of lateral support is provided regardless of rotational orientation of the end effector head. For example, there may be three or four lateral support structures evenly distributed around the perimeter. In another variation, there may be a continuous support structure surrounding the edge of the end-effector piece.

A head holder or tool holder (38) device functions to hold the end effector heads when not in use. In one variation, the holder is a rack with a set of defined open slots that can hold a plurality of end effector heads. In one implementation, the holder includes a slot that is open so that an end effector head can be slid into the slot. The holder slot can additionally engage around a neck of the end effector head so that the robotic system can pull perpendicular to disengage the head selector from the current end effector head. Conversely, when selecting a new end effector head, the actuation system can move the head selector into approximate position around the opening of the end effector head, slide the end effector head out of the holder slot, and the magnetic elements pull the end effector head onto the head selector.

The head holder device may include indexing structures that moves an end effector head into a desired position when engaged. This can be used if the features of the changeable end effector system need the orientation of the end effectors to be in a known position.

The sensing system function to collect data of the objects and the environment. The sensing system preferably includes an imaging system, which functions to collect image data. The imaging system preferably includes at least one imaging device (10) with a field of view in a first region. The first region can be where the object interactions are expected. The imaging system may additionally include multiple imaging devices (12, 14, 16, 18), such as digital camera sensors, used to collect image data from multiple perspectives of a distinct region, overlapping regions, and/or distinct non-overlapping regions. The set of imaging devices (e.g., one imaging device or a plurality of imaging devices) may include a visual imaging device (e.g., a camera). The set of imaging devices may additionally or alternatively include other types of imaging devices such as a depth camera. Other suitable types of imaging devices may additionally or alternatively be used.

The imaging system preferably captures an overhead or aerial view of where the objects will be initially positioned and moved to. More generally, the image data that is collected is from the general direction from which the robotic system would approach and grasp an object. In one variation, the collection of objects presented for processing is presented in a substantially unorganized collection. For example, a collection of various objects may be temporarily stored in a box or tote (in stacks and/or in disorganized bundles). In other variations, objects may be presented in a substantially organized or systematic manner. In one variation, objects may be placed on a conveyor built that is moved within range of the robotic system. In this variation, objects may be substantially separate from adjacent objects such that each object can be individually handled.

The system preferably includes a grasp planning processing pipeline (6) that is used to determine how to grab an object from a set of objects and optionally what tool to grab the object with. The processing pipeline can make of heuristic models, conditional checks, statistical models, machine learning or other data-based modeling, and/or other processes. In one preferred variation, the pipeline includes an image data segmenter, a grasp quality model is used to generate an initial set of candidate grasp plans, and then a grasp plan selection process or processes that use the set of candidate grasp plans.

The image data segmenter can segments image data to generate one or more image masks. The set of image masks could include object masks, object collection masks (e.g., segmenting multiple bins, totes, shelves, etc.), object feature masks (e.g., a barcode mask), and/or other suitable types of masks. Image masks can be used in a grasp quality model and/or in a grasp plan selection process.

The grasp quality model functions to convert image data and optionally other input data into an output of a set of candidate grasp plans. The grasp quality model may include parameters of a deep neural network, support vector machine, random forest, and/or other machine learning models. In one variation, training a grasp quality model can include or be a convolutional neural network (CNN). The parameters of the grasp quality model will generally be optimized to substantially maximize (or otherwise enhance) performance on a training dataset, which can include a set of images, grasp plans for a set of points on images, and grasp results for those grasp plans (e.g., success or failure).

In one exemplary implementation, a grasp quality CNN is a model trained so that for an input of image data (e.g., visual or depth), the model can output a tensor/vector characterizing the unique tool, pose (position and/or orientation for centering a grasp), and probability of success. The grasp planning model and/or an additional processing model may additionally integrate modeling for object selection order, material-based tool selection, and/or other decision factors.

The training dataset may include real or synthetic images labeled manually or automatically. In one variation, simulation reality transfer learning can be used to train the grasp quality model. Synthetic images may be created by generating virtual scenes in simulation using a database of thousands of 3D object models with randomized textures and rendering virtual images of the scene using techniques from graphics.

A grasp plan selection process preferably assesses the set of candidate grasp plans from the grasp quality model and selects a grasp plan for execution. Preferably, a single grasp plan is selected though in some variations, such as if there are multiple robotic systems operating simultaneously, multiple grasp plans can be selected and executed in coordination to avoid interference. A grasp plan selection process can assess the probability of success of the top candidate grasp plans and evaluate time impact for changing a tool if some top candidate grasp plans are for a tool that is not the currently attached tool.

In some variations, the system may include a workstation configuration module. A workstation configuration module can be software implemented as machine interpretable instructions stored on a data storage medium that when performed by one or more computer processors cause the workstation configuration to output a user interface directing definition of environment conditions. A configuration tool may be attached as an end effector and used in marking and locating coordinates of key features of various environment objects.

The system may additionally include an API interface to various environment implemented systems. The system may include an API interface to an external system such as a warehouse management system (WMS), a warehouse control system (WCS), a warehouse execution system (WES), and/or any suitable system that may be used in receiving instructions and/or information on object locations and identity. In another variation, there may be an API interface into various order requests, which can be used in determining how to pack a collection of products into boxes for different orders.

Referring to FIGS. 7A-7F, various aspects of a robotic package handing configuration are illustrated. Referring to FIG. 7A, a central frame (64) with multiple elements may be utilized to couple various components, such as a robotic arm (54), place structure (56), pick structure (62), and computing enclosure (60). As described in the aforementioned incorporated references, a movable component (58) of the place structure may be utilized to capture items from the place structure (56) and deliver them to various other locations within the system (52). FIG. 7B illustrates a closer view of the system (52) embodiment, wherein the pick structure (62) illustrated comprises a bin defining a package containment volume bounded by a bottom and a plurality of walls, and may define an open access aperture to accommodate entry and egress of a portion of the robot arm, along with viewing by an imaging device (66). In other embodiments the pick structure may comprise a fixed surface such as a table, a movable surface such as a conveyor belt system, or tray. Referring to FIG. 7C, the system may comprise a plurality of imaging devices configured to capture images of various aspects of the operation. Such imaging devices may comprise monochrome, grayscale, or color devices, and may comprise depth camera devices, such as those sold under the tradename RealSense (RTM) by Intel Corporation. A first imaging device (66) may be fixedly coupled to an element of the frame (64) and may be positioned and oriented to capture images with a field of view (80) oriented down into the pick structure (62), as shown in FIG. 7C. A second imaging device (66) may be coupled to an element of the frame (64) and positioned and oriented to capture image information pertaining to end end effector (4) of the robotic arm (54), as well as image information pertaining to a captured or grasped package which may be removably coupled to the end effector (4) after a successful grasp. Such image information may be utilized to estimate outer dimensional bounds of the grasped item or package, such as by fitting a 3-D rectangular prism around the targeted package and estimating length-width-height (L-W-H) of the rectangular prism. The 3-D rectangular prism to estimate a position and an orientation of the targeted package relative to the end effector. The imaging devices may be automatically triggered by the intercoupled computing system (60). The computing system may be configured to estimate whether the targeted package is deformable by capturing a sequence of images of the targeted package during motion of the at targeted package and analyzing deformation of the targeted package within the sequence of images, such as by observing motion within regions of the images of the package during motion or acceleration of the package by the robotic arm (i.e., a rigid package would have regions that generally move together in unison; a compliant package may have regions with do not move in unison with accelerations and motions). As shown in FIGS. 7C and 7D, various additional imaging devices (74, 76, 78) may be positioned and oriented to provide fields of view (84, 86, 88) which may be useful in observing the activity of the robotic arm (54) and associated packages.

Referring to FIG. 7E, a vacuum load source (90), such as a source of pressurized air or gas which may be controllably (such as by electromechanically controllable input valves operatively coupled to the computing system, with integrated pressure and/or velocity sensors for closed-loop control) circulated through a venturi configuration and operatively coupled (such as via a conduit) to the end effector assembly to produce a controlled vacuum load for suction-cup assemblies and suction-based end effectors (4).

FIG. 7F illustrates a closer view of a robotic arm (54) with end effector assembly (24) comprising two suction cup assemblies (26, 28) configured to assist in grasping a package, as described further in the aforementioned incorporated references. Referring to FIGS. 8A, 8B, and 7G, one embodiment of a suction cup assembly (26) is illustrated showing a vacuum coupling (104) coupled to an outer housing (92) which may comprise a bellows structure comprising a plurality of foldable wall portions coupled at bending margins; such a bellows structure may comprise a material selected from the group consisting of: polyethylene, polypropylene, rubber, and thermoplastic elastomer. An intercoupled inner internal structure (94) may comprise a wall member (114), such as a generally cylindrically shaped wall member as shown, as well as a proximal base member (112) which may define a plurality of inlet apertures (102) therethrough; it may further comprise a distal wall member (116) which defines an inner structural aperture ring portion, a plurality of transitional air channels (108), and an outer sealing lip member (96); it may further define an inner chamber (100). A gap (106) may be defined between potions of the outer housing member (92) and internal structure (94), such that vacuum from the vacuum source tends to pull air through the inner chamber (100), as well as associated inlet apertures (102) and transitional air channels using a prescribed path configured to assist in grasping while also preventing certain package surface overprotrusions with generally non-compliant packages.

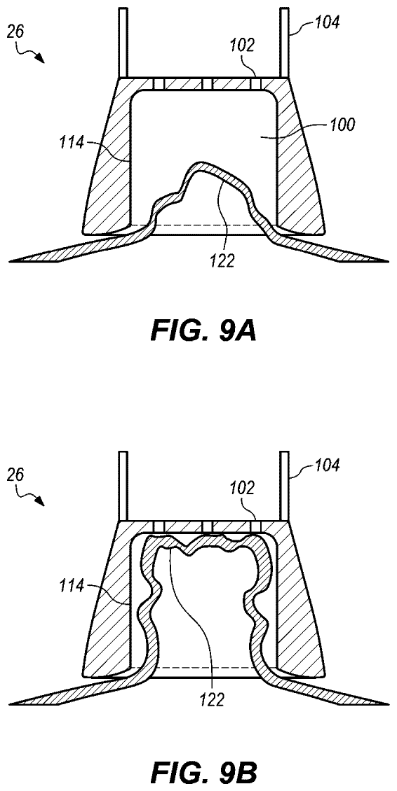

Referring to FIGS. 9A and 9B, as described in the aforementioned incorporated references, with a compliant package or portion thereof, the system may be configured to pull a compliant portion (122) up into the inner chamber (100) to ensure a relatively confident grasp with a compliant package, such as to an extent that the package portion (122) is at least partially encapsulating the package portion (122), as shown in FIG. 9B.

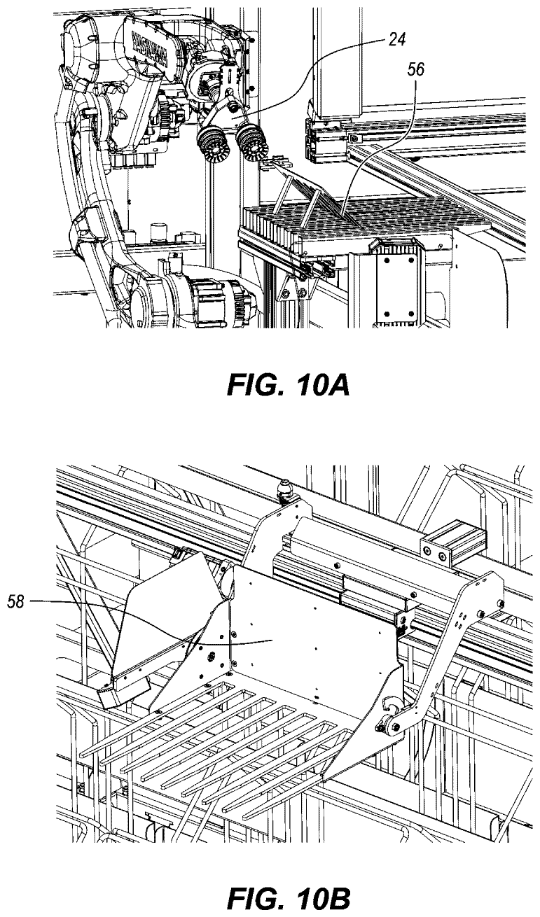

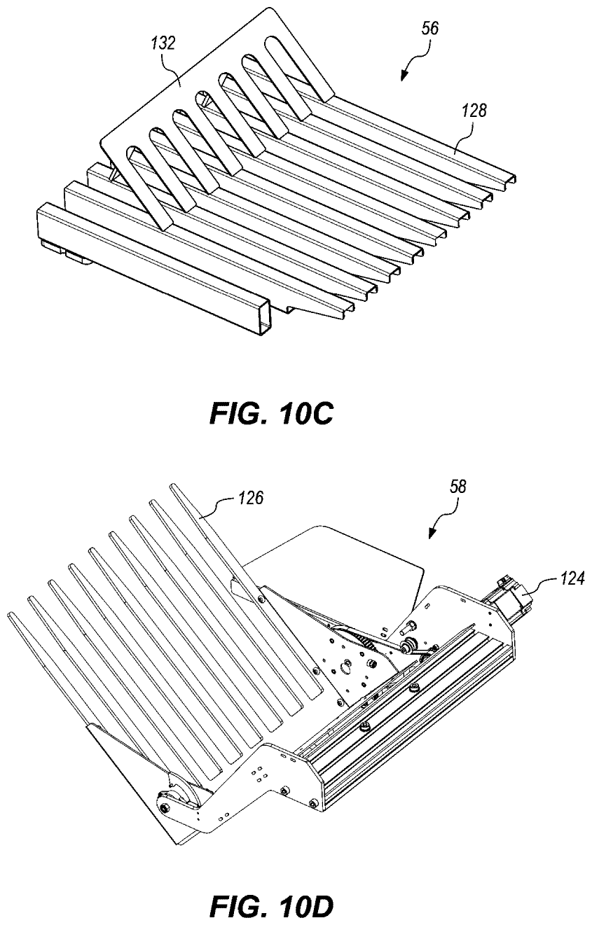

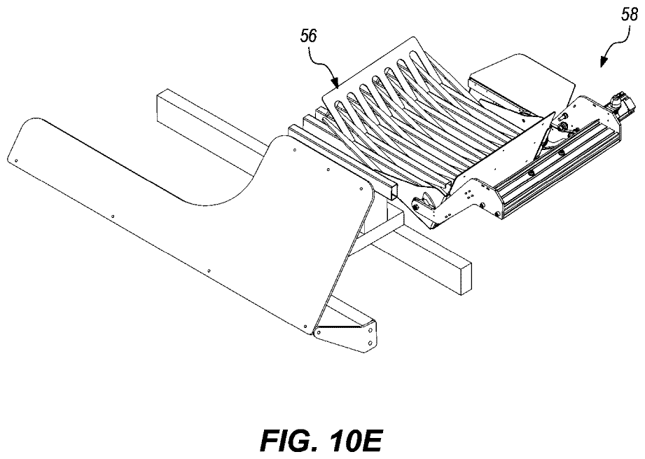

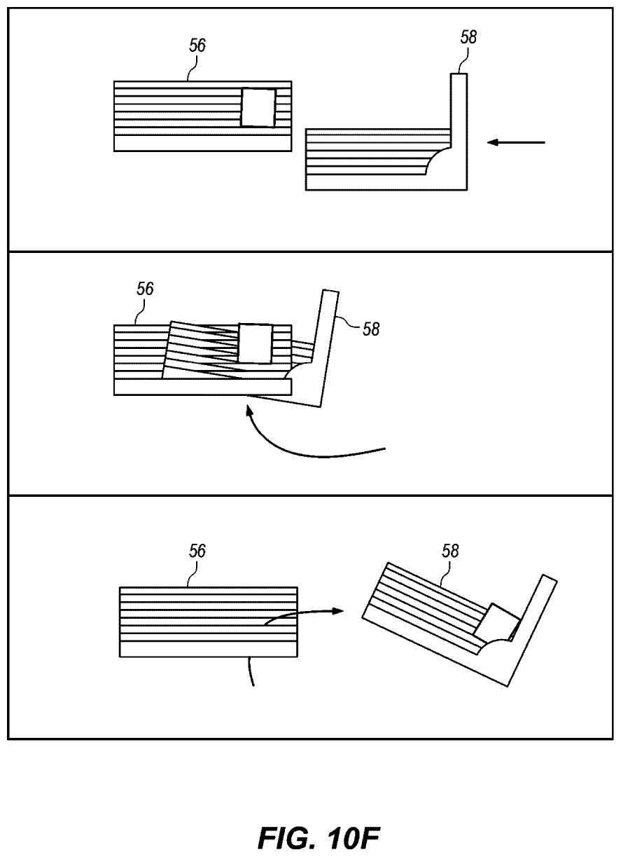

Referring to FIGS. 10A-10F, as noted above, the place structure (56) may comprise a component (58) which may be rotatably and/or removably coupled to the remainder of the place structure (56) to assist in distribution of items from the place structure (56). As shown in FIG. 10C, the place structure (56) may comprise a grill-like, or interrupted, surface configuration (128) with a retaining ramp (132) configured to accommodate rotatable and/or removable engagement of the complementary component (58), such as shown in FIG. 10D, which may have a forked or interrupted configuration (126) to engage the other place structure component (56). FIG. 10F schematically illustrates aspects of movable and rotatable engagement between the structures (56, 58), as described in the aforementioned incorporated references.

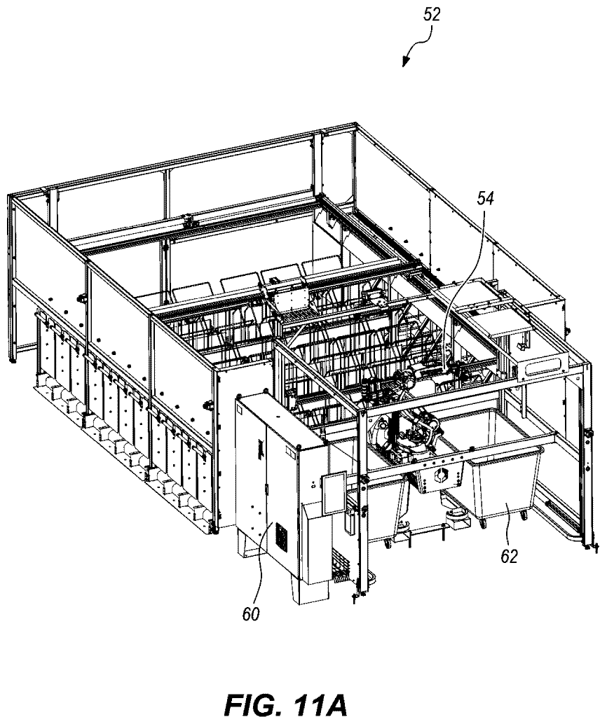

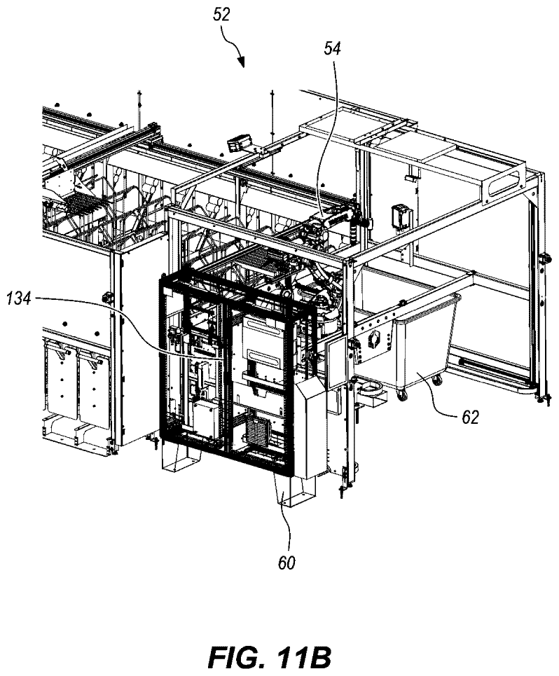

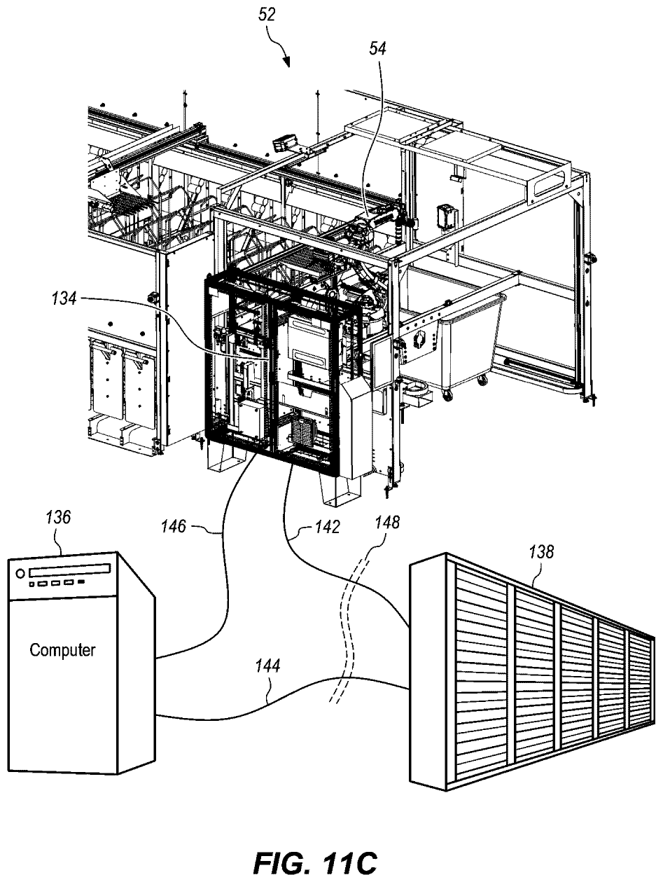

Referring to the system (52) configuration of FIG. 11A, as noted above, a computing system, such as a VLSI computer, may be housed within a computing system housing structure (60). FIG. 11B illustrates a view of the system of FIG. 11A, but with the housing shown as transparent to illustrate the computing system (134) coupled inside. Referring to FIG. 11C, in other embodiments, additional computing resources may be operatively coupled (142, 144, 146) (such as by fixed network connectivity, or wireless connectivity such as configurations under the IEEE 802.11 standards); for example, the system may comprise an additional VLSI computer (136), and/or certain cloud-computing based computer resources (138), which may be located at one or more distant/non-local (148) locations.

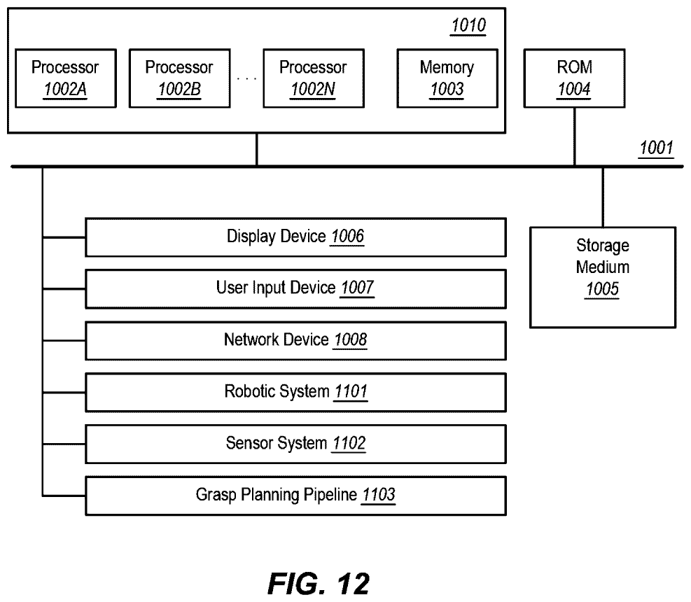

Referring to FIG. 12, an exemplary computer architecture diagram of one implementation of the system. In some implementations, the system is implemented in a plurality of devices in communication over a communication channel and/or network. In some implementations, the elements of the system are implemented in separate computing devices. In some implementations, two or more of the system elements are implemented in same devices. The system and portions of the system may be integrated into a computing device or system that can serve as or within the system.

The communication channel 1001 interfaces with the processors 1002A-1202N, the memory (e.g., a random-access memory (RAM)) 1003, a read only memory (ROM) 1004, a processor-readable storage medium 1005, a display device 1006, a user input device 1007, and a network device 1008. As shown, the computer infrastructure may be used in connecting a robotic system 1101, a sensor system 1102, a grasp planning pipeline 1103, and/or other suitable computing devices.

The processors 1002A-1002N may take many forms, such CPUs (Central Processing Units), GPUs (Graphical Processing Units), microprocessors, ML/DL (Machine Learning/Deep Learning) processing units such as a Tensor Processing Unit, FPGA (Field Programmable Gate Arrays, custom processors, and/or any suitable type of processor.

The processors 1002A-1002N and the main memory 1003 (or some sub-combination) can form a processing unit 1010. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip). In some embodiments, the processing unit includes one or more of the elements of the system.

A network device 1008 may provide one or more wired or wireless interfaces for exchanging data and commands between the system and/or other devices, such as devices of external systems. Such wired and wireless interfaces include, for example, a universal serial bus (USB) interface, Bluetooth interface, Wi-Fi interface, Ethernet interface, near field communication (NFC) interface, and the like.

Computer and/or Machine-readable executable instructions comprising of configuration for software programs (such as an operating system, application programs, and device drivers) can be stored in the memory 1003 from the processor-readable storage medium 1005, the ROM 1004 or any other data storage system.

When executed by one or more computer processors, the respective machine-executable instructions may be accessed by at least one of processors 1002A-1002N (of a processing unit 1010) via the communication channel 1001, and then executed by at least one of processors 1002A-1002N. Data, databases, data records or other stored forms data created or used by the software programs can also be stored in the memory 1003, and such data is accessed by at least one of processors 1002A-1002N during execution of the machine-executable instructions of the software programs.

The processor-readable storage medium 1005 is one of (or a combination of two or more of) a hard drive, a flash drive, a DVD, a CD, an optical disk, a floppy disk, a flash storage, a solid-state drive, a ROM, an EEPROM, an electronic circuit, a semiconductor memory device, and the like. The processor-readable storage medium 1005 can include an operating system, software programs, device drivers, and/or other suitable subsystems or software.

As used herein, first, second, third, etc. are used to characterize and distinguish various elements, components, regions, layers and/or sections. These elements, components, regions, layers and/or sections should not be limited by these terms. Use of numerical terms may be used to distinguish one element, component, region, layer and/or section from another element, component, region, layer and/or section. Use of such numerical terms does not imply a sequence or order unless clearly indicated by the context. Such numerical references may be used interchangeable without departing from the teaching of the embodiments and variations herein.

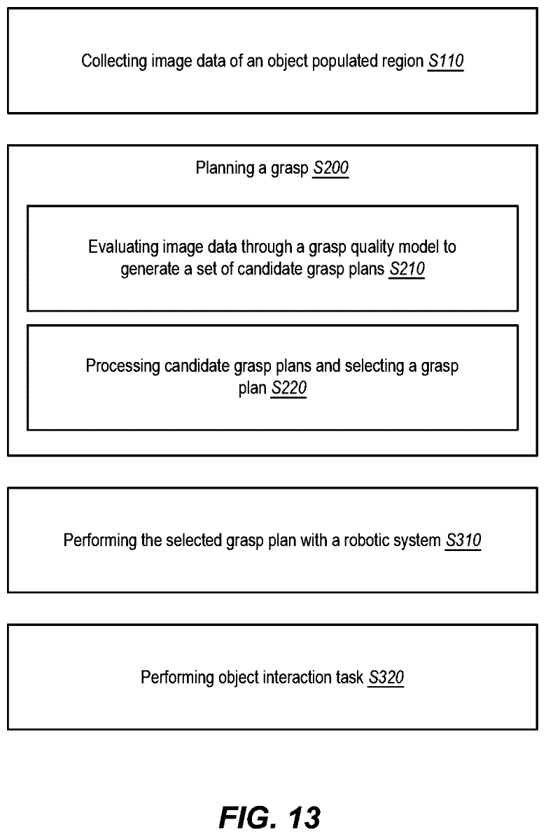

As shown in FIG. 13, a method for planning and adapting to object manipulation by a robotic system can include: collecting image data of an object populated region S110; planning a grasp S200 comprised of evaluating image data through a grasp quality model to generate a set of candidate grasp plans S210 and processing candidate grasp plans and selecting a grasp plan S220; performing the selected grasp plan with a robotic system S310 and performing object interaction task S320. The grasp quality model preferably integrates grasp quality across a set of different robotic tools and therefore selection of a grasp plan can trigger changing of a tool. For a pick-and-place robot this can include changing the end effector head based on the selected grasp plan.

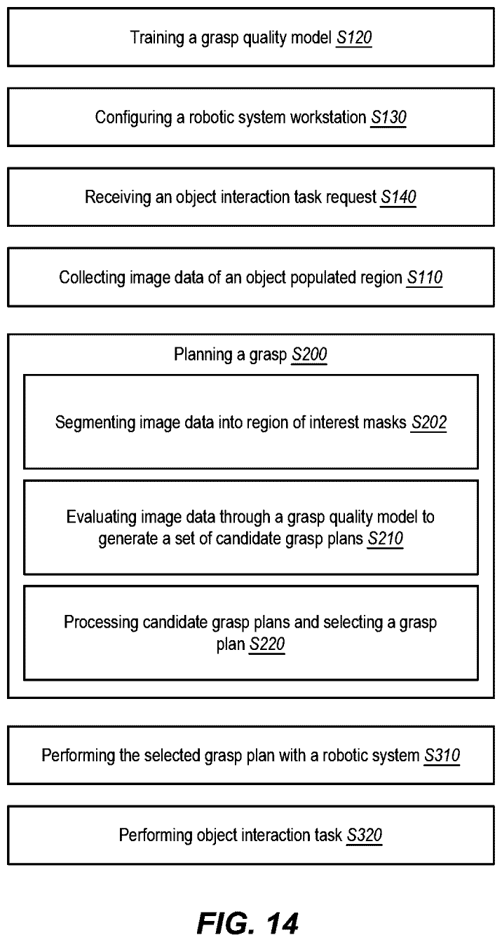

In a more detailed implementation shown in FIG. 14, the method can included training a grasp quality model S120; configuring a robotic system workstation S130; receiving an object interaction task request S140 and triggering collecting image data of an object populated region S110; planning a grasp S200 which includes segmenting image data into region of interest masks S202, evaluating image data through the grasp quality model to generate a set of candidate grasp plans S210, and processing candidate grasp plans and selecting a grasp plan S220; performing the selected grasp plan with a robotic system S310 and performing object interaction task S320.

The method may be implemented by a system such as the system described herein, but the method may alternatively be implemented by any suitable system.

In one variation, the method can include training a grasp quality convolutional neural network S120, which functions to construct a data-driven model for scoring different grasp plans for a given set of image data.

The grasp quality model may include parameters of a deep neural network, support vector machine, random forest, and/or other machine learning models. In one variation, training a grasp quality model can include or is a convolutional neural network (CNN). The parameters of the grasp quality model will generally be optimized to substantially maximize (or otherwise enhance) performance on a training dataset, which can include a set of images, grasp plans for a set of points on images, and grasp results for those grasp plans (e.g., success or failure).

In one exemplary implementation, a grasp quality CNN is trained so that for an input of image data (e.g., visual or depth), the model can output a tensor/vector characterizing the unique tool, pose (position and/or orientation for centering a grasp), and probability of success.

The training dataset may include real or synthetic images labeled manually or automatically. In one variation, simulation reality transfer learning can be used to train the grasp quality model. Synthetic images may be created by generating virtual scenes in simulation using a database of thousands of 3D object models with randomized textures and rendering virtual images of the scene using techniques from graphics.

The grasp quality model may additionally integrate other features or grasp planning scoring into the model. In one variation, the grasp quality model integrates object selection order into the model. For example, a CNN can be trained using the metrics above, but also to prioritize selection of large objects so as to reveal smaller objects underneath and potentially revealing other higher probability grasp points. In other variations, various algorithmic heuristics or processes can be integrated to account for object size, object material, object features like barcodes, or other features.

During execution of the method, the grasp quality model may additionally be updated and refined, as image data of objects is collected, grasp plans executed, and object interaction results determined. In some variations, a grasp quality model may be provided, wherein training and/or updating of the grasp quality model may not be performed by the entity executing the method.

In one variation, the method can include configuring a robotic system workstation S130, which functions to setup a robotic system workstation for operation. Configuring the robotic system workstation preferably involves configuring placement of features of the environment relative to the robotic system. For example, in a warehouse example, configuring the robotic system workstation involves setting coordinate positions of where a put-wall, a set of shelves, a box, an outbagger, a conveyor belt, or other regions where objects may be located or will be placed.

In one variation, configuring a robotic system can include the robotic system receiving manual manipulation of a configuration tool used as the end effector to define various geometries. A user interface can preferably guide the user through the process. For example, within the user interface, a set of standard environmental objects can be presented in a menu. After selection of the object, instructions can be presented guiding a user through a set of measurements to be made with the configuration end effector.

Configuration may also define properties of defined objects in the environment. This may provide information useful in avoiding collisions, defining how to plan movements in different regions, and interact with objects based on the relevant environment objects. An environment object may be defined as being static to indicate the environment object does not move. An environment object may be defined as being mobile. For some mobile environment objects, a region in which the mobile environment object is expected may also be defined. For example, the robotic system workstation can be configured to understand the general region in which a box of objects may appear as well as the dimensions of the expected box. Various object specific features such as size and dimensions of moving parts (e.g., doors, box flaps) can also be configured. For example, the position of a conveyor along with the conveyor path can be configured. The robotic system may additionally be integrated with a suitable API to have data on conveyor state.

In one variation, the method can include receiving an object interaction task request S140, which functions to have some signal initiate object interactions by the robotic system. They request may specify where an object is located and more typically where a collection of objects is located. The request may additionally supply instructions or otherwise specify the action to take on the object. The object interaction task request may be received through an API. In one implementation an external system such as a warehouse management system (WMS), a warehouse control system (WCS), a warehouse execution system (WES), and/or any suitable system may be used in directing interactions such as specifying which tote should be used for object picking.

In one variation, the method may include receiving one or a more requests. The requests may be formed around the intended use case. In one example, the requests may be order requests specifying groupings of a set of objects. Objects specified in an order request will generally need to be bod, packaged or otherwise grouped together for further order processing. The selection of objects may be at least partially based on the set of requests, priority of the requests, and planned fulfillment of these orders. For example, an order with two objects that may be selected from one or more bins with high confidence may be selected for object picking and placing by the system prior to an object from an order request where the object is not identified or has lower confidence in picking capability at this time.

Block S110, which includes collecting image data of an object populated region, functions to observe and sense objects to be handled by a robotic system for processing. In some use-cases, the set of objects will include one or a plurality of types of products. Collecting image data preferably includes collecting visual image data using a camera system. In one variation, a single camera may be used. In another variation, multiple cameras may be used. Collecting image data may additionally or alternatively include collecting depth image data or other forms of 2D or 3D data from a particular region.

In one preferred implementation collecting image data includes capturing image data from an overhead or aerial perspective. More generally, the image data is collected from the general direction from which a robotic system would approach and grasp an object. The image data is preferably collected in response to some signal such as an object interaction task request. The image data may alternatively be continuously or periodically processed to automatically detect when action should be taken.

Block S200, which includes planning a grasp, functions to determine which object to grab, how to grab the object and optionally which tool to use. Planning a grasp can make use of a grasp planning model in densely generating different grasps options and scoring them based on confidence and/or other metrics. In one variation, planning a grasp can include: segmenting image data into region of interest masks S202, evaluating image data through a neural network architecture to generate a set of candidate grasp plans S210, and processing candidate grasp plans and selecting a grasp plan S220. Preferably, the modeling used in planning a grasp, attempts to increase object interaction throughput. This can function to address the challenge of balancing probability of success using a current tool against the time cost of switching to a tool with higher probability of success.

Block S202, which includes segmenting image data into region of interest masks, functions to generate masks used in evaluating the image data in block S210. Preferably, one or more segmentation masks are generated from supplied image data input. Segmenting image data can include segmenting image data into object masks. Segmenting image data may additionally or alternatively include segmenting image data into object collections (e.g., segmenting on totes, bins, shelves, etc.). Segmenting image data may additionally or alternatively include segmenting image data into object feature masks. Object feature masks may be used in segmenting detected or predicted object features such as barcodes or other object elements. There are some use cases where it is desirable to avoid grasping on particular features or to strive for grasping particular features.

Block S210, which includes evaluating image data through a grasp quality model to generate a set of candidate grasp plans, functions to output a set of grasp options from a set of input data. The image data is preferably one input into the grasp quality model. One or more segmentation masks from block S202 may additionally be supplied as input. Alternatively, the segmentation masks may be used to eliminate or select sections of the image data for where candidate grasps should be evaluated.

Preferably, evaluating image data through the grasp quality model includes evaluating the image data through a grasp quality CNN architecture. The grasp quality CNN can densely predict for multiple locations in the image data what are the grasp qualities for each tool and what is the probability of success if a grasp were to be performed. The output is preferably a map of tensor/vectors characterizing the tool, pose (position and/or orientation for centering a grasp), and probability of success.

As mentioned above, the grasp quality CNN may model object selection order, and so the output may also score grasp plans according to training data reflecting object order. In another variation, object material planning can be integrated into the grasp quality CNN or as an additional planning model used in determining grasps. Material planning process could classify image data as a map for handling a collection of objects of differing material. Processing of image data with a material planning process may be used in selection of new tool. For example, if a material planning model indicates a large number of polybag wrapped objects, then a tool change may be triggered based on the classified material properties from a material model.

Block S220, which includes processing candidate grasp plans and selecting a grasp plan, functions to apply various heuristics and/or modeling in prioritizing the candidate grasp plans and/or selecting a candidate grasp plan. The output of the grasp quality model is preferably fed into subsequent processing stages that weigh different factors. A subset of the candidate grasp plans that have a high probability of success may be evaluated. Alternatively, all grasp plans may alternatively be processed in S220.

Part of selecting a candidate grasp plan is selecting a grasp plan based in part on the time cost of a tool change and the change in probability of a successful grasp. This can be considered for the current state of objects but also considered across the previous activity and potential future activity. In one preferred variation, the current tool state and grasp history (e.g., grasp success history for given tools) can be supplied as inputs. For example, if there were multiple failures with a given tool then that may inform the selection of a grasp plan with a different tool. When processing candidate grasp plans, there may be a bias towards keeping the same tool. Changing a tool takes time, and so the change in the probability of a successful grasp is weighed against the time cost for changing tools.

Some additional heuristics such as collision checking, feature avoidance, and other grasp heuristic conditions can additionally be assessed when planning a grasp. In a multi-headed end effector tool variation, collision checking may additionally account for collisions and obstructions potentially accounted by the end effector heads not in use.

Block S310, which includes performing the selected grasp plan with a robotic system, functions to control the robotic system to grasp the object in the manner specified in the selected grasp plan.

Since the grasp plans are preferably associated with different tools, performing selected grasp plan using the indicated tool of the grasp plan may include selecting and/or changing the tool.

In a multi-headed end effector tool variation, the indicated tool (or tools) may be appropriately activated or used as a target point for aligning with the object. Since the end effector heads may be offset from the central axis of an end arm segment, motion planning of the actuation system preferably modifies actuation to appropriately align the correct head in a desired position.

In a changeable tool variation, if the current tool is different from the tool of the selected grasp plan, then the robotic system uses a tool change system to change tools and then executes the grasp plan. If the current tool is the same as the tool indicated in the selected grasp plan, then the robotic system moves to execute the grasp plan directly.

When performing the grasp plan an actuation system moves the tool (e.g., the end effector suction head) into position and executes a grasping action. In the case of a pressure-based pick-and-place machine, executing a grasping action includes activating the pressure system. During grasping, the tool (i.e., the end effector) of the robotic system will couple with the object. Then the object can be moved and manipulated for subsequent interactions. Depending on the type of robotic system and end effector, grasping may be performed through a variety of grasping mechanisms and/or end effectors.

In the event that there are no suitable grasp plans identified in block S200, the method may include grasping and reorienting objects to present other grasp plan options. After reorientation, the scene of the objects can be re-evaluated to detect a suitable grasp plan. In some cases, multiple objects may be reoriented. Additionally or alternatively, the robotic system may be configured to disturb a collection of objects to perturb the position of multiple objects with the goal of revealing a suitable grasp point.

Once an object is grasped it is preferably extracted from the set of objects and then translated to another position and/or orientation, which functions to move and orient an object for the next stage.

If, after executing the grasp plan (e.g., when grasping an object or during performing object interaction task), the object is dropped or otherwise becomes disengaged from the robotic system, then the failure can be recorded. Data of this even can be used in updating the system and the method can include reevaluating the collection of objects for a new grasp plan. Similarly, data records for successful grasps can also be used in updating the system and the grasp quality modeling and other grasp planning processes.

Block S320, which includes performing object interaction task, functions to perform any object manipulation using the robotic system with a grasped object. The object interaction task may involve placing the object in a target destination (e.g., placing in another bin or box), changing orientation of object prior to placing the object, moving the object for some object operation (e.g., such as barcode scanning), and/or performing any suitable action or set of actions. In one example, performing an object interaction task can involve scanning a barcode or other identifying marker on an object to detect an object identifier and then placing the object in a destination location based on the object identifier. When used in a facility used to fulfill shipment orders, a product ID obtained with the barcode information is used to look up a corresponding order and then determine which container maps to that order-the object can then be placed in that container. When performed repeatedly, multiple products for an order can be packed into the same container. In other applications, other suitable subsequent steps may be performed. Grasp failure during object interaction tasks can result in regrasping the object and/or returning to the collection of objects for planning and execution of a new object interaction. Regrasping an object may involve a modified grasp planning process that is focused on a single object at the site where the dropped object fell.

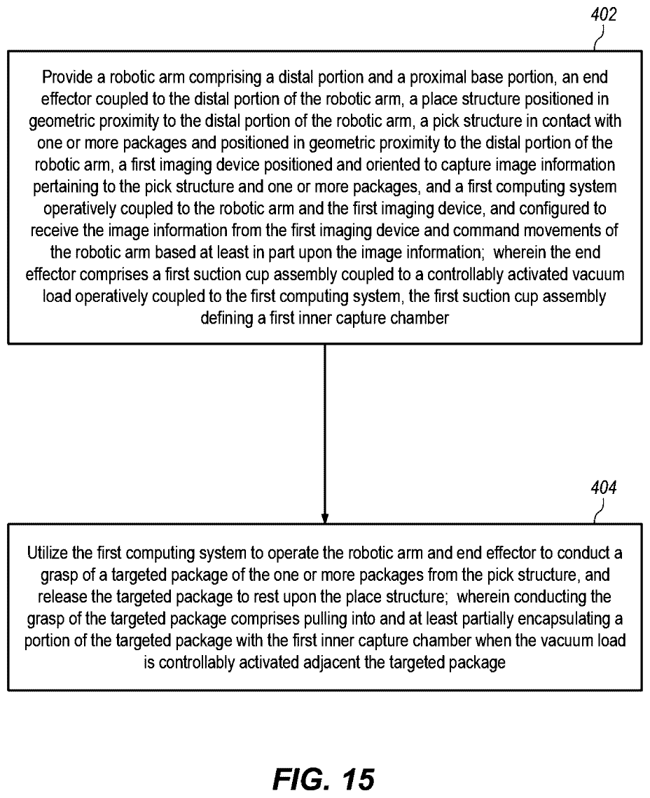

Referring to FIGS. 15-19, various method configurations are illustrated. Referring to FIG. 15, one embodiment comprises providing a robotic arm comprising a distal portion and a proximal base portion, an end effector coupled to the distal portion of the robotic arm, a place structure positioned in geometric proximity to the distal portion of the robotic arm, a pick structure in contact with one or more packages and positioned in geometric proximity to the distal portion of the robotic arm, a first imaging device positioned and oriented to capture image information pertaining to the pick structure and one or more packages, and a first computing system operatively coupled to the robotic arm and the first imaging device, and configured to receive the image information from the first imaging device and command movements of the robotic arm based at least in part upon the image information; wherein the end effector comprises a first suction cup assembly coupled to a controllably activated vacuum load operatively coupled to the first computing system, the first suction cup assembly defining a first inner capture chamber (402); and utilizing the first computing system to operate the robotic arm and end effector to conduct a grasp of a targeted package of the one or more packages from the pick structure, and release the targeted package to rest upon the place structure; wherein conducting the grasp of the targeted package comprises pulling into and at least partially encapsulating a portion of the targeted package with the first inner capture chamber when the vacuum load is controllably activated adjacent the targeted package (404).

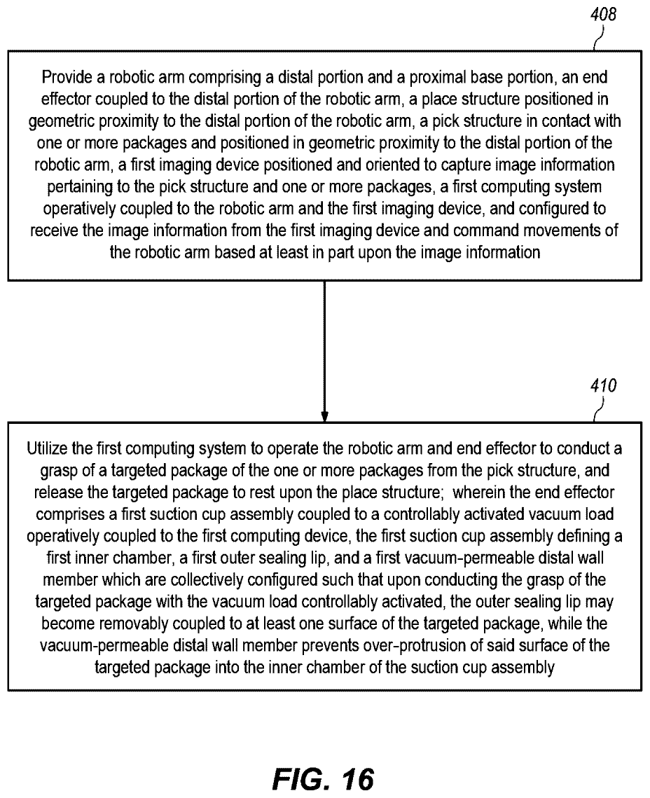

Referring to FIG. 16, one embodiment comprises providing a robotic arm comprising a distal portion and a proximal base portion, an end effector coupled to the distal portion of the robotic arm, a place structure positioned in geometric proximity to the distal portion of the robotic arm, a pick structure in contact with one or more packages and positioned in geometric proximity to the distal portion of the robotic arm, a first imaging device positioned and oriented to capture image information pertaining to the pick structure and one or more packages, a first computing system operatively coupled to the robotic arm and the first imaging device, and configured to receive the image information from the first imaging device and command movements of the robotic arm based at least in part upon the image information (408); and utilizing the first computing system to operate the robotic arm and end effector to conduct a grasp of a targeted package of the one or more packages from the pick structure, and release the targeted package to rest upon the place structure; wherein the end effector comprises a first suction cup assembly coupled to a controllably activated vacuum load operatively coupled to the first computing device, the first suction cup assembly defining a first inner chamber, a first outer sealing lip, and a first vacuum-permeable distal wall member which are collectively configured such that upon conducting the grasp of the targeted package with the vacuum load controllably activated, the outer sealing lip may become removably coupled to at least one surface of the targeted package, while the vacuum-permeable distal wall member prevents over-protrusion of said surface of the targeted package into the inner chamber of the suction cup assembly.

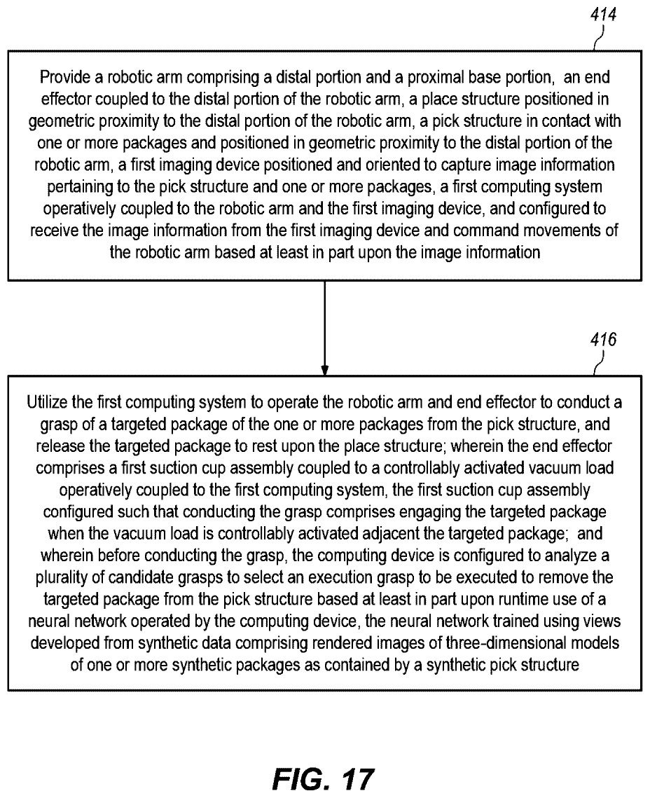

Referring to FIG. 17, one embodiment comprises providing a robotic arm comprising a distal portion and a proximal base portion, an end effector coupled to the distal portion of the robotic arm, a place structure positioned in geometric proximity to the distal portion of the robotic arm, a pick structure in contact with one or more packages and positioned in geometric proximity to the distal portion of the robotic arm, a first imaging device positioned and oriented to capture image information pertaining to the pick structure and one or more packages, a first computing system operatively coupled to the robotic arm and the first imaging device, and configured to receive the image information from the first imaging device and command movements of the robotic arm based at least in part upon the image information (414); and utilizing the first computing system to operate the robotic arm and end effector to conduct a grasp of a targeted package of the one or more packages from the pick structure, and release the targeted package to rest upon the place structure; wherein the end effector comprises a first suction cup assembly coupled to a controllably activated vacuum load operatively coupled to the first computing system, the first suction cup assembly configured such that conducting the grasp comprises engaging the targeted package when the vacuum load is controllably activated adjacent the targeted package; and wherein before conducting the grasp, the computing device is configured to analyze a plurality of candidate grasps to select an execution grasp to be executed to remove the targeted package from the pick structure based at least in part upon runtime use of a neural network operated by the computing device, the neural network trained using views developed from synthetic data comprising rendered images of three-dimensional models of one or more synthetic packages as contained by a synthetic pick structure (416).

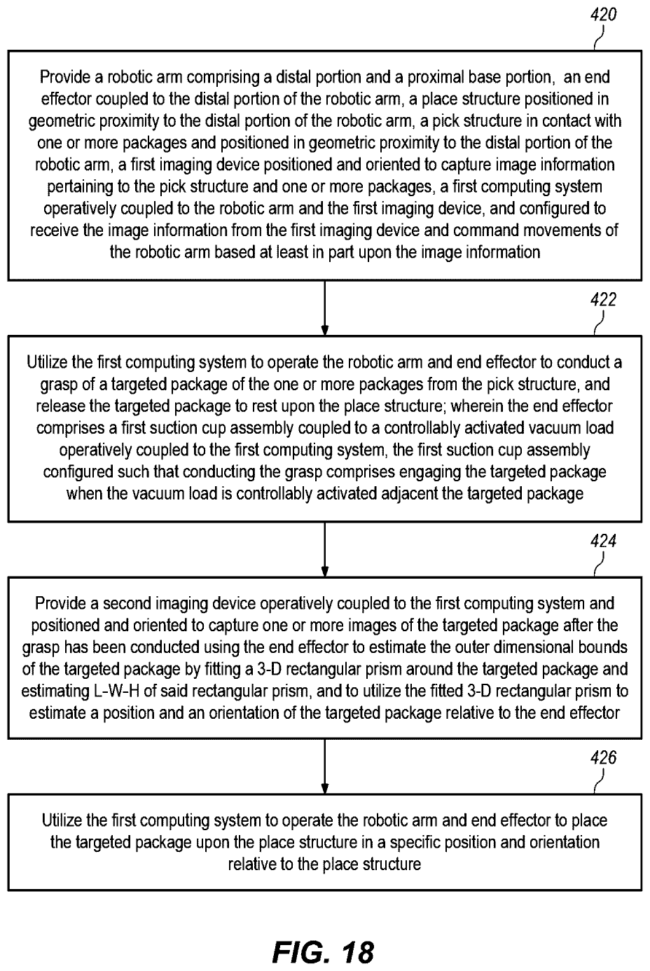

Referring to FIG. 18, one embodiment comprises providing a robotic arm comprising a distal portion and a proximal base portion, an end effector coupled to the distal portion of the robotic arm, a place structure positioned in geometric proximity to the distal portion of the robotic arm, a pick structure in contact with one or more packages and positioned in geometric proximity to the distal portion of the robotic arm, a first imaging device positioned and oriented to capture image information pertaining to the pick structure and one or more packages, a first computing system operatively coupled to the robotic arm and the first imaging device, and configured to receive the image information from the first imaging device and command movements of the robotic arm based at least in part upon the image information (420); utilizing the first computing system to operate the robotic arm and end effector to conduct a grasp of a targeted package of the one or more packages from the pick structure, and release the targeted package to rest upon the place structure; wherein the end effector comprises a first suction cup assembly coupled to a controllably activated vacuum load operatively coupled to the first computing system, the first suction cup assembly configured such that conducting the grasp comprises engaging the targeted package when the vacuum load is controllably activated adjacent the targeted package (422); providing a second imaging device operatively coupled to the first computing system and positioned and oriented to capture one or more images of the targeted package after the grasp has been conducted using the end effector to estimate the outer dimensional bounds of the targeted package by fitting a 3-D rectangular prism around the targeted package and estimating L-W-H of said rectangular prism, and to utilize the fitted 3-D rectangular prism to estimate a position and an orientation of the targeted package relative to the end effector (424); and utilizing the first computing system to operate the robotic arm and end effector to place the targeted package upon the place structure in a specific position and orientation relative to the place structure (426).

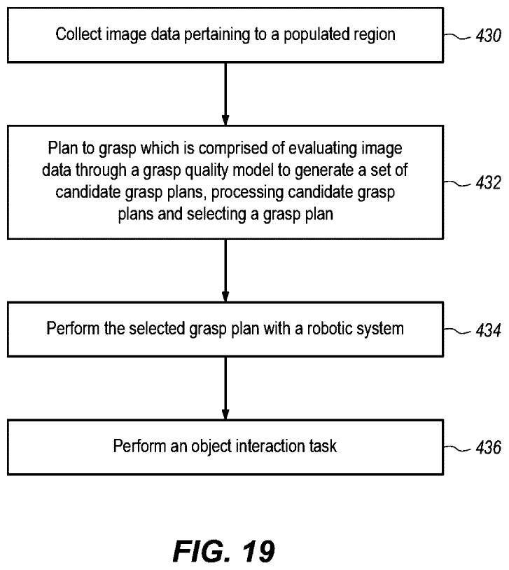

Referring to FIG. 19, one embodiment comprises collecting image data pertaining to a populated region (430); planning a grasp which is comprised of evaluating image data through a grasp quality model to generate a set of candidate grasp plans, processing candidate grasp plans and selecting a grasp plan (432); performing the selected grasp plan with a robotic system (434); and performing an object interaction task (436).

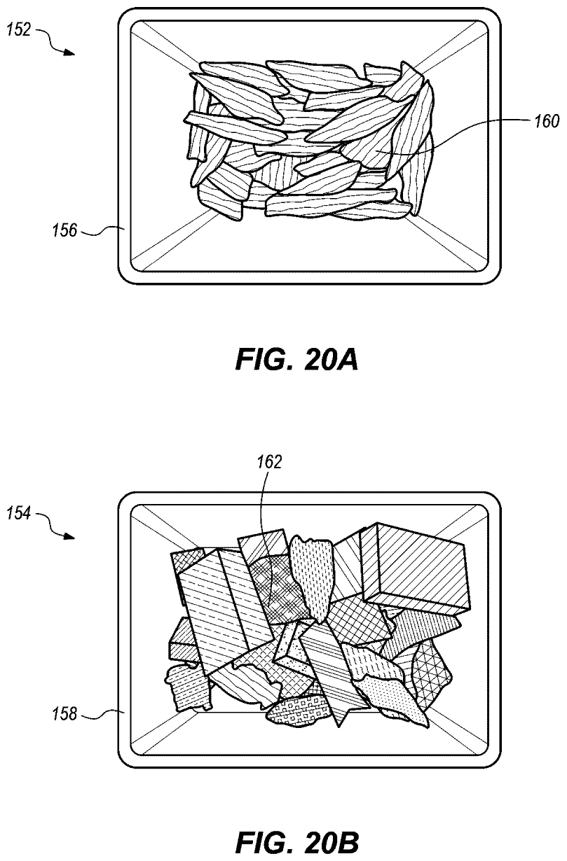

Referring to FIGS. 20A and 20B, two synthetic training images (152, 154) are shown, each featuring a synthetic pick structure bin (156, 158) containing a plurality of synthetic packages (160, 162). Synthetic volumes may be created and utilized to create large numbers of synthetic image data, such as is shown in FIGS. 20A and 20B, to rapidly train a neural network to facilitate automatic operation of the robotic arm in picking targeted packaged from the pick structure and placing them on the place structure. Views may be created from a plurality of viewing vectors and positions, and the synthetic volumes may be varied as well. For example, the neural network may be trained using views developed from synthetic data comprising rendered color images of three-dimensional models of one or more synthetic packages as contained by a synthetic pick structure; it also may be trained using views developed from synthetic data comprising rendered depth images of three-dimensional models of one or more synthetic packages as contained by a synthetic pick structure; it also may be trained using views developed from synthetic data comprising rendered images of three-dimensional models of one or more randomized synthetic packages as contained by a synthetic pick structure; it also may be trained using synthetic data wherein the synthetic packages are randomized by color texture; further, it may also be trained using synthetic data wherein the synthetic packages are randomized by a physically-based rendering mapping selected from the group consisting of: reflection, diffusion, translucency, transparency, metallicity, and microsurface scattering; further the neural network may be trained using views developed from synthetic data comprising rendered images of three-dimensional models of one or more synthetic packages in random positions and orientations as contained by a synthetic pick structure.

The first computing system may be configured such that conducting the grasp comprises analyzing a plurality of candidate grasps to select an execution grasp to be executed to remove the targeted package from the pick structure. Analyzing a plurality of candidate grasps may comprise examining locations on the targeted package where the first suction cup assembly is predicted to be able to form a sealing engagement with a surface of the targeted package. Analyzing a plurality of candidate grasps may comprise examining locations on the targeted package where the first suction cup assembly is predicted to be able to form a sealing engagement with a surface of the targeted package from a plurality of different end effector approach orientations. Analyzing a plurality of candidate grasps comprises examining locations on the targeted package where the first suction cup assembly is predicted to be able to form a sealing engagement with a surface of the targeted package from a plurality of different end effector approach positions. A first suction cup assembly may comprise a first outer sealing lip, wherein a sealing engagement with a surface comprises a substantially complete engagement of the first outer sealing lip with the surface. Examining locations on the targeted package where the first suction cup assembly is predicted to be able to form a sealing engagement with a surface of the targeted package may be conducted in a purely geometric fashion. A first computing system may be configured to select the execution grasp based upon a candidate grasps factor selected from the group consisting of: estimated time required; estimated computation required; and estimated success of grasp.

The system may be configured such that a single neural network is able to predict grasps for multiple types of end effector or tool configurations (i.e., various combinations of numbers of suction cup assemblies; also various vectors of approach). The system may be specifically configured to not analyze torques and loads, such as at the robotic arm or in other members, relative to targeted packages in the interest of system processing speed (i.e., in various embodiments, with packages for mailing, it may be desirable to prioritize speed over torque or load based analysis).

As noted above, in various embodiments, to randomize the visual appearance of items in the synthetic/simulated training data, the system may be configured to randomize a number of properties that are used to construct the visual representation (including but not limited to: color texture, which may comprise base red-green-blue values that may be applied to the three dimensional model; also physically-based rendering maps, which may be applied to the surfaces, may be utilized, including but not limited to reflection, diffusion, translucency, transparency, metallicity, and/or microsurface scattering).

Various exemplary embodiments of the invention are described herein. Reference is made to these examples in a nonlimiting sense. They are provided to illustrate more broadly applicable aspects of the invention. Various changes may be made to the invention described and equivalents may be substituted without departing from the true spirit and scope of the invention. In addition, many modifications may be made to adapt a particular situation, material, composition of matter, process, process act(s) or step(s) to the objective(s), spirit or scope of the present invention. Further, as will be appreciated by those with skill in the art that each of the individual variations described and illustrated herein has discrete components and features which may be readily separated from or combined with the features of any of the other several embodiments without departing from the scope or spirit of the present inventions. All such modifications are intended to be within the scope of claims associated with this disclosure.

The invention includes methods that may be performed using the subject devices. The methods may comprise the act of providing such a suitable device. Such provision may be performed by the end user. In other words, the “providing” act merely requires the end user obtain, access, approach, position, set-up, activate, power-up or otherwise act to provide the requisite device in the subject method. Methods recited herein may be carried out in any order of the recited events which is logically possible, as well as in the recited order of events.

Exemplary aspects of the invention, together with details regarding material selection and manufacture have been set forth above. As for other details of the present invention, these may be appreciated in connection with the above-referenced patents and publications as well as generally known or appreciated by those with skill in the art. The same may hold true with respect to method-based aspects of the invention in terms of additional acts as commonly or logically employed.

In addition, though the invention has been described in reference to several examples optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. In addition, where a range of values is provided, it is understood that every intervening value, between the upper and lower limit of that range and any other stated or intervening value in that stated range, is encompassed within the invention.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in claims

associated hereto, the singular forms “a,” “an,” “said,” and “the” include plural referents unless the specifically stated otherwise. In other words, use of the articles allow for “at least one” of the subject item in the description above as well as claims associated with this disclosure. It is further noted that such claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in claims associated with this disclosure shall allow for the inclusion of any additional element—irrespective of whether a given number of elements are enumerated in such claims, or the addition of a feature could be regarded as transforming the nature of an element set forth in such claims. Except as specifically defined herein, all technical and scientific terms used herein are to be given as broad a commonly understood meaning as possible while maintaining claim validity.

The breadth of the present invention is not to be limited to the examples provided and/or the subject specification, but rather only by the scope of claim language associated with this disclosure.

1. (canceled)

2. A robotic package handling system, comprising:
a. a robotic arm comprising a distal portion and a proximal base portion;
b. an end effector coupled to the distal portion of the robotic arm;
c. a place structure positioned in geometric proximity to the distal portion of the robotic arm;
d. a pick structure in contact with one or more packages and positioned in geometric proximity to the distal portion of the robotic arm;
e. a first imaging device positioned and oriented to capture image information pertaining to the pick structure and one or more packages;
f. a first computing system operatively coupled to the robotic arm and the first imaging device, and configured to receive the image information from the first imaging device and command movements of the robotic arm based at least in part upon the image information;
wherein the first computing system is configured to operate the robotic arm and end effector to conduct a grasp of a targeted package of the one or more packages from the pick structure, and release the targeted package to rest upon the place structure; and
wherein the end effector comprises a first suction cup assembly coupled to a controllably activated vacuum load operatively coupled to the first computing system, the first suction cup assembly configured such that conducting the grasp comprises engaging the targeted package when the vacuum load is controllably activated adjacent the targeted package;
wherein the system further comprises a second imaging device operatively coupled to the first computing system and positioned and oriented to capture one or more images of the targeted package after the grasp has been conducted using the end effector to estimate the outer dimensional bounds of the targeted package by fitting a 3-D rectangular prism around the targeted package and estimating L-W-H of said rectangular prism, and to utilize the fitted 3-D rectangular prism to estimate a position and an orientation of the targeted package relative to the end effector; and
wherein the first computing system is configured to operate the robotic arm and end effector to place the targeted package upon the place structure in a specific position and orientation relative to the place structure.

3. The system of claim 2, further comprising a frame structure configured to fixedly couple the robotic arm to the place structure.

4. The system of claim 3, wherein the pick structure is removably coupled to the frame structure.

5. The system of claim 2, wherein the place structure comprises a placement tray.

6. The system of claim 5, wherein the placement tray comprises first and second rotatably coupled members, the first and second rotatably coupled members being configured to form a substantially flat tray base surface when in a first rotated configuration relative to each other, and to form a lifting fork configuration when in a second rotated configuration relative to each other.

7. The system of claim 5, wherein the placement tray is operatively coupled to one or more actuators configured to controllably change an orientation of at least a portion of the placement tray, the one or more actuators being operatively coupled to the first computing system.

8. The system of claim 2, wherein the pick structure comprises an element selected from the group consisting of: a bin, a tray, a fixed surface, and a movable surface.

9. The system of claim 8, wherein the pick structure comprises a bin configured to define a package containment volume bounded by a bottom and a plurality of walls, as well as an open access aperture configured to accommodate entry and egress of at least the distal portion of the robotic arm.

10. The system of claim 9, wherein the first imaging device is configured to capture the image information pertaining to the pick structure and one or more packages through the open access aperture.

11. The system of claim 2, wherein the first imaging device comprises a depth camera.

12. The system of claim 2, wherein the first imaging device is configured to capture color image data.

13. The system of claim 2, wherein the first computing system comprises a single VLSI computer.

14. The system of claim 2, wherein the first computing system comprises a network of intercoupled computing devices, at least one of which is remotely located relative to the robotic arm.

15. The system of claim 2, further comprising a second computing system operatively coupled to the first computing system.

16. The system of claim 15, wherein the second computing system is remotely located relative to the first computing system, and the first and second computing systems are operatively coupled via a computer network.

17. The system of claim 2, wherein the first computing system is configured such that conducting the grasp comprises analyzing a plurality of candidate grasps to select an execution grasp to be executed to remove the targeted package from the pick structure.

18. The system of claim 17, wherein analyzing a plurality of candidate grasps comprises examining locations on the targeted package where the first suction cup assembly is predicted to be able to form a sealing engagement with a surface of the targeted package.

19. The system of claim 18, wherein analyzing a plurality of candidate grasps comprises examining locations on the targeted package where the first suction cup assembly is predicted to be able to form a sealing engagement with a surface of the targeted package from a plurality of different end effector approach orientations.

20. The system of claim 18, wherein analyzing a plurality of candidate grasps comprises examining locations on the targeted package where the first suction cup assembly is predicted to be able to form a sealing engagement with a surface of the targeted package from a plurality of different end effector approach positions.

21. The system of claim 18, wherein the first suction cup assembly comprises a first outer sealing lip, and wherein a sealing engagement with a surface comprises a substantially complete engagement of the first outer sealing lip with the surface.

22. The system of claim 18, wherein examining locations on the targeted package where the first suction cup assembly is predicted to be able to form a sealing engagement with a surface of the targeted package is conducted in a purely geometric fashion.

23. The system of claim 17, wherein the first computing system is configured to select the execution grasp based upon a candidate grasps factor selected from the group consisting of: estimated time required; estimated computation required; and estimated success of grasp.

24. The system of claim 2, wherein the first suction cup assembly comprises a bellows structure.

25. The system of claim 24, wherein the bellows structure comprises a plurality of wall portions adjacently coupled with bending margins.

26. The system of claim 25, wherein the bellows structure comprises a material selected from the group consisting of: polyethylene, polypropylene, rubber, and thermoplastic elastomer.

27. The system of claim 2, wherein the first suction cup assembly comprises an outer housing and an internal structure coupled thereto.

28. The system of claim 27, wherein the internal structure of the first suction cup assembly comprises a wall member coupled to a proximal base member, the wall member and proximal base member defining an inner chamber.

29. The system of claim 28, wherein the wall member comprises a substantially cylindrical shape having proximal and distal ends, and wherein the proximal base member forms a substantially circular interface with the proximal end of the wall member.

30. The system of claim 28, wherein the proximal base member defines one or more inlet apertures therethrough, the one or more inlet apertures being configured to allow air flow therethrough in accordance with activation of the controllably activated vacuum load.

31. The system of claim 30, wherein the internal structure further comprises a distal wall member comprising a structural aperture ring portion configured to define access to the inner chamber, as well as one or more transitional air channels configured to allow air flow therethrough in accordance with activation of the controllably activated vacuum load.

32. The system of claim 31, wherein the one or more inlet apertures and the one or more transitional air channels function to allow a prescribed flow of air through the inner chamber to facilitate releasable coupling of the first suction cup assembly with the targeted package.

33. The system of claim 2, wherein the one or more packages are selected from the group consisting of: a bag, a “poly bag”, a “poly”, a fiber-based bag, a fiber-based envelope, a bubble-wrap bag, a bubble-wrap envelope, a “jiffy” bag, a “jiffy” envelope, and a substantially rigid cuboid structure.

34. The system of claim 32, wherein the one or more packages comprise a fiber-based bag comprising a paper composite or polymer composite.

35. The system of claim 33, wherein the one or more packages comprise a fiber-based envelope comprising a paper composite or polymer composite.

36. The system of claim 33, wherein the one or more packages comprise a substantially rigid cuboid structure comprising a box.

37. The system of claim 2, wherein the end effector comprises a second suction cup assembly coupled to the controllably activated vacuum load.

38. The system of claim 37, wherein the second suction cup assembly defines a second inner chamber configured to pull into and at least partially encapsulate a portion of the targeted package when the vacuum load is controllably activated adjacent the targeted package.

39. The system of claim 2, further comprising a third imaging device operatively coupled to the first computing system and positioned and oriented to capture one or more images of the targeted package after the grasp has been conducted using the end effector.

40. The system of claim 2, wherein the second imaging device and first computing system are further configured to estimate whether the targeted package is deformable by capturing a sequence of images of the targeted package during motion of the at targeted package and analyzing deformation of the targeted package within the sequence of images.

41. The system of claim 2, wherein the first computing system and second imaging device are configured to capture and utilize the one or more images after the grasp has been conducted using the end effector to estimate whether a plurality of packages, or zero packages, have been yielded with the conducted grasp.

42. The system of claim 41, wherein the first computing system is configured to abort a grasp upon determination that a plurality of packages, or zero packages, have been yielded with the conducted grasp.

43. The system of claim 2, wherein the end effector comprises a tool switching head portion configured to controllably couple to and uncouple from the first suction cup assembly using a tool holder mounted within geometric proximity of the distal portion of the robotic arm.

44. The system of claim 43, wherein the tool holder is configured to hold and be removably coupled to one or more additional suction cup assemblies or one or more other package interfacing tools, such that the first computing device may be configured to conduct tool switching using the tool switching head portion.

45. The system of claim 2, wherein the first computing system is configured to operate the robotic arm and end effector to place with targeted package upon the place structure such that the targeted package is dragged into a ramp comprising the place structure.

46. The system of claim 2, wherein the first computing system is configured to operate the robotic arm and end effector to place with targeted package upon the place structure such that the targeted package is placed upon an edge of the targeted package intentionally such that it will topple onto a surface of the place structure in a preferred orientation and position.

47. The system of claim 2, wherein the first computing system is configured to operate the robotic arm and end effector to place with targeted package upon the place structure such that the targeted package is swept across a surface of the place structure to remain substantially flat relative to the surface.
